(19) United States
(12) Patent Application Publication
(10) Pub. No.: US 2008/0089563 A1
(43) Pub. Date: Apr. 17, 2008

(54) Information processing apparatus having image comparing function

(75) Inventors: Manabu Yumoto, Nara-shi (JP); Masayuki Ehiro, Izumi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/806,510

(22) Filed: May 31, 2007

(30) Foreign Application Priority Data
Jun. 2, 2006 (JP) 2006-154820(P)

(51) Int. Cl. G06K 9/00

(52) U.S. Cl. 382/124

(57) ABSTRACT

An element determining unit detects an element that should be excluded from an object of comparison, of an image. Using the image with the detected element removed, comparing process is performed. Specifically, a feature value calculating unit calculates, in correspondence to each of a plurality of partial images in the image, a feature value in accordance with a pattern of the corresponding portion. The element determining unit detects an area represented by a combination of partial images having a prescribed calculated feature value, as the element to be excluded from the object of comparison. Based on the ratio of the detected elements as non-eligible for comparison to the image as a whole and on the result of comparison, activation of an application is permitted/inhibited.

This nonprovisional application is based on Japanese Patent Application No. 2006-154820 filed with the Japan Patent Office on Jun. 2, 2006 the entire contents of which are hereby incorporated by reference.

### BACKGROUND OF THE INVENTION

1. Field of the Invention

The present invention relates to an information processing apparatus and, more specifically, to an information processing apparatus having a function of comparing images.

2. Description of the Background Art

Conventionally, an apparatus receiving as an input biometrics data such as fingerprint image information uniquely identifying an individual and executing personal authentication process based on the input biometrics data has been introduced. In the process of personal authentication, the input biometrics data must have high quality. If the quality is low, according to Japanese Patent Laying-Open No. 2001-167053, authentication process using data as an alternative to the fingerprint image, such as a password, is executed. According to Japanese Patent Laying-Open No. 2001-167053, if personal authentication using fingerprint data (hereinafter referred to as fingerprint authentication) is not satisfactory, authentication using a password as an alternative to the fingerprint is executed in addition to the fingerprint authentication. Based on the result of these authentications, a prescribed process (such as a log-in to a computer system) that requires proper security is executed.

According to the laid-open patent application mentioned above, when fingerprint authentication is unsatisfactory, an additional authentication process is performed using data as an alternative to the fingerprint. This requires additional hardware resource for the authentication based on the alternative data. Further, increase in speed of authentication process is hindered by the additional authentication process. Further, it is not convenient for the user, as input of alternative data is required in addition to the fingerprint.

### SUMMARY OF THE INVENTION

An object of the present invention is to provide an information processing apparatus that controls, when an application processing unit requiring security (crime prevention, safety etc.) at the time of activation is to be operated based on processing of images identifying individuals, permission/inhibition of activation of the application processing unit without sacrificing user convenience and maintaining required level of security.

In order to attain the object, according to an aspect, the present invention provides an information processing apparatus performing a process based on a result of comparison of an image for identifying an individual, including: a feature value detecting unit for detecting and outputting, in correspondence with each of partial images of the image as an input, a feature value in accordance with a pattern represented by the partial image; a non-eligibility detecting unit for detecting a partial image to be excluded from an object of a comparing process in the input image, based on the feature value output by the feature value detecting unit; a comparing unit for performing the comparing process using the input image with the partial image detected by the non-eligibility detecting unit excluded; and a ratio calculating unit for calculating ratio of the partial image detected to be excluded from the object by the non-eligibility detecting unit, relative to the input image as a whole; wherein permission or inhibition of a designated application process is controlled by a result of the comparing process by the comparing unit and by the ratio calculated by the ratio calculating unit.

Preferably, to the designated application process a security level required for activating the application process is allocated in advance; and permission or inhibition of a designated application process is controlled by a result of the comparing process by the comparing unit and a result of comparison between the ratio calculated by the ratio calculating unit and the allocated security level.

Preferably, in the comparing process, the input image with the partial image detected by the non-eligibility detecting unit excluded is compared with a reference image prepared in advance; and when a result of the comparing process indicates a mismatch between the input image and the reference image, permission or inhibition of the designated application process is controlled by the ratio calculated by the ratio calculating unit.

Preferably, the non-eligibility detecting-unit detects a combination of the partial images having a prescribed feature value output by the feature value detecting unit.

Preferably, the image represents a fingerprint pattern; and the feature value output by the feature value detecting unit is classified into a value indicating that the pattern of the partial image runs along a vertical direction of the fingerprint, a value indicating that it runs along a horizontal direction of the fingerprint, and a value indicating otherwise.

Preferably, the image represents a fingerprint pattern; and the feature value output by the feature value detecting unit is classified into a value indicating that the pattern of the partial image runs along a right oblique direction of the fingerprint, a value indicating that it runs along a left oblique direction of the fingerprint, and a value indicating otherwise.

Preferably, the prescribed feature value represents the value indicating otherwise.

Preferably, the combination consists of a plurality of the partial images having the value indicating otherwise, positioned adjacent to each other in a prescribed direction in the input image.

Preferably, the comparing unit includes a position searching unit for searching, in each of a plurality of partial areas of a reference image prepared in advance to be an object of comparison, a position of an area attaining maximum matching score with the partial image, in the partial areas excluding the area of the partial image detected by the non-eligibility detecting unit in the input image, a similarity score calculating unit for calculating a similarity score between the input image and the reference image, based on information of the partial area of which positional relation amount corresponds to a prescribed amount, the positional relation amount representing positional relation between a reference position for measuring, for each of the plurality of partial areas, a position of the partial area in the reference image and a position of maximum matching score corresponding to the partial area searched by the position searching unit, and for outputting the calculated score as an image similarity score; and a determining unit for determining whether the input image and the reference image match with each other, based on the applied image similarity score.

Preferably, the similarity score calculating unit calculates, among the plurality of partial areas, the number of the partial areas of which direction and distance from the reference position of the corresponding maximum matching score position searched by the position searching unit correspond to the prescribed amount, and outputs the result of calculation as the image similarity score.

Preferably, the positional relation amount indicates direction and distance of the maximum matching score position to the reference position.

Preferably, the apparatus further includes an image input unit for inputting an image; wherein the image input unit has a reading surface on which a finger is placed, for reading a fingerprint image of the finger placed thereon.

In order to attain the object, according to another aspect, the present invention provides a method of information processing, for performing a process based on a result of comparison of an image for identifying an individual, using a computer, including the steps of: detecting, in correspondence with each of partial images of the image as an input, a feature value in accordance with a pattern represented by the partial image; detecting a partial image to be excluded from an object of a comparing process in the input image, based on the output feature value; performing the comparing process using the input image with the detected partial image excluded; and calculating ratio of the partial image detected to be excluded from the object, relative to the input image as a whole; wherein permission or inhibition of a designated application process is controlled by a result of the comparing process by the step of performing the comparing process and by the ratio calculated by the ratio calculating step.

According to a further aspect, the present invention provides an information processing program for causing a computer to execute the information processing method described above.

According to a still further aspect, the present invention provides a computer readable recording medium recording an information processing program for causing a computer to execute the information processing method described above.

According to the present invention, activation of the designated application process is permitted or inhibited dependent on the result of comparing process by the comparing unit and on the ratio calculated by the ratio calculating unit. Specifically, based on the result of comparing process and on the ratio of the partial image area excluded from the object of comparison in the compared image to the entire image, that is, information representing accuracy of the result of comparison, whether activation of the application processing should be permitted or inhibited is controlled. Therefore, even when the ratio is high and it is difficult to guarantee accuracy of the comparison result, activation can be permitted/inhibited in consideration of the ratio (accuracy of comparison result) without requiring the user to input different personal information such as a password or requiring repeated image input and comparing process.

Further, even when a good image is not available because of a dirt or the like on the input image, whether activation of the application processing should be permitted or inhibited is controlled in accordance with the result of comparison between the level of security required to permit activation of the application process and the ratio occupied by the partial image not eligible for comparison due to dirt or the like. Therefore, whether activation of the application processing should be permitted or inhibited can be controlled in consideration of the security level suitable for the designated application processing unit provided in the information processing apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a processing apparatus having an authentication function in accordance with an embodiment of the present invention.

FIG. 2 shows a configuration of a computer on which the processing apparatus having the authentication function of the present invention is mounted.

FIG. 3 shows a configuration of a fingerprint sensor in accordance with an embodiment of the present invention.

FIG. 4 shows a configuration of a security rank table in accordance with an embodiment of the present invention.

FIG. 5 is a flowchart of a comparing process in accordance with an embodiment of the present invention.

FIG. 6 illustrates image pixels for calculating three different types of feature values in accordance with an embodiment of the present invention.

FIG. 7 is a flowchart for calculating the three different types of feature values in accordance with an embodiment of the present invention.

FIG. 8 is a flowchart of a process for obtaining the maximum number of consecutive black pixels in the horizontal direction in accordance with an embodiment of the present invention.

FIG. 9 is a flowchart of a process for obtaining the maximum number of consecutive black pixels in the vertical direction in accordance with an embodiment of the present invention.

FIGS. 10A to 10F schematically illustrate a process for calculating an image feature value in accordance with an embodiment of the present invention.

FIGS. 11A to 11C show a flowchart and partial images to be referred to in a process for calculating a partial image feature value in accordance with an embodiment of the present invention.

FIG. 12 is a flowchart of a process for calculating an amount of pixel increase when a partial image is displaced to the left and right in accordance with an embodiment of the present invention.

FIG. 13 is a flowchart of a process for calculating an amount of pixel increase when a partial image is displaced upward and downward in accordance with an embodiment of the present invention.

FIG. 14 is a flowchart of a process for calculating a difference between an image obtained by displacing the partial image upward and downward or to the left and to the right and the original partial image, in accordance with an embodiment of the present invention.

FIGS. 15A to 15F schematically illustrate a process for calculating an image feature value in accordance with an embodiment of the present invention.

FIGS. 16A to 16C show a flowchart and partial images to be referred to in a process for calculating a partial image feature value in accordance with an embodiment of the present invention.

FIG. 17 is a flowchart of a process for determining an amount of pixel increase when a partial image is displaced in a right oblique direction in accordance with an embodiment of the present invention.

FIG. 18 is a flowchart of a process for determining an amount of pixel increase when a partial image is displaced in a left oblique direction in accordance with an embodiment of the present invention.

FIG. 19 is a flowchart of a process for calculating a difference between an image obtained by displacing the partial image in left or right oblique direction and the original partial image, in accordance with an embodiment of the present invention.

FIG. 20 is a flowchart of a process for calculating a partial image feature value in accordance with an embodiment of the present invention.

FIGS. 21A to 21C illustrate a specific example of the comparing process in accordance with an embodiment of the present invention.

FIGS. 22A to 22C illustrate a specific example of the comparing process in accordance with an embodiment of the present invention.

FIG. 23 is a flowchart of a maximum matching score position searching and similarity score calculating process in accordance with an embodiment of the present invention.

FIGS. 24A to 24F show specific examples of the comparing process in accordance with an embodiment of the present invention.

FIG. 25 is a flowchart of a process for determining an element non-eligible for comparison in accordance with an embodiment of the present invention.

FIGS. 26A to 26F schematically illustrate comparison procedure in consideration of the element non-eligible for comparison in accordance with an embodiment of the present invention.

FIG. 27 is a flowchart of a process for determining whether execution of an application is to be permitted, in accordance with an embodiment of the present invention.

### DESCRIPTION OF THE PREFERRED EMBODIMENTS

In the following, embodiments of the present invention will be described with reference to the figures. Though it is assumed here that the object image represents fingerprint patterns, it is not limiting and the image may have any pattern unique to an individual, such as a retina pattern or a vein pattern.

### Embodiment 1

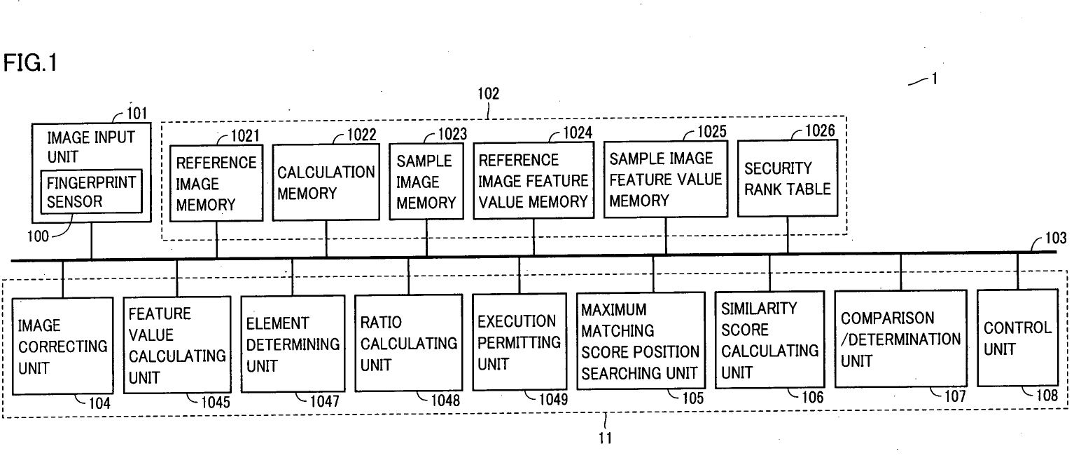

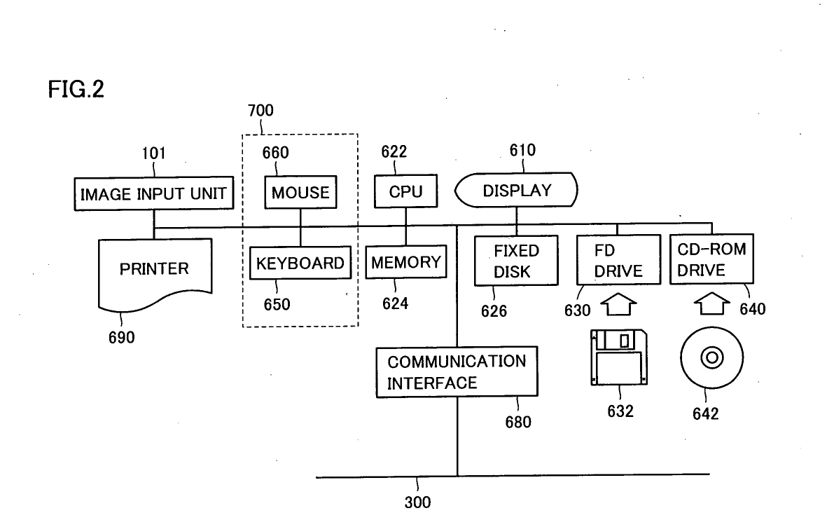

FIG. 1 is a block diagram of a processing apparatus 1 having an authentication function in accordance with Embodiment 1. FIG. 2 shows a configuration of a computer (information processing apparatus) on which the processing apparatus having the authentication function in accordance with each embodiment is mounted. Referring to FIG. 2, the computer includes an image input unit 101, a display 610 such as a CRT (Cathode Ray Tube) or a liquid crystal display, a CPU (Central Processing Unit) 622 for central management and control of the computer, a memory 624 including a ROM (Read Only Memory) or a RAM (Random Access Memory), a fixed disk 626, an FD drive 630 to which an FD (flexible disk) 632 is detachably mounted and which accesses the mounted FD 632, a CD-ROM drive 640 to which a CD-ROM (Compact Disc Read Only Memory) 642 is detachably mounted and which accesses the mounted CD-ROM 642, a communication interface 680 for connecting the computer to a communication network 300 for establishing communication, a printer 690, and an input unit 700 having a keyboard 650 and a mouse 660. These components are connected through a bus for communication.

The computer may be provided with a magnetic tape apparatus accessing a cassette-type magnetic tape that is detachably mounted thereon.

Referring to FIG. 1, processing apparatus 1 having the authentication function includes an image input unit 101, a memory 102 that corresponds to memory 624 or fixed disk 626 shown in FIG. 2, a bus 103 and a processing unit 11.

Image input unit 101 includes a fingerprint sensor 100. Image input unit 101 outputs image data of the fingerprint read by fingerprint sensor 100. Fingerprint sensor 100 may be any of optical, pressure, and static-capacitance type sensors. Control signals and data signals between each of these units are transferred through bus 103.

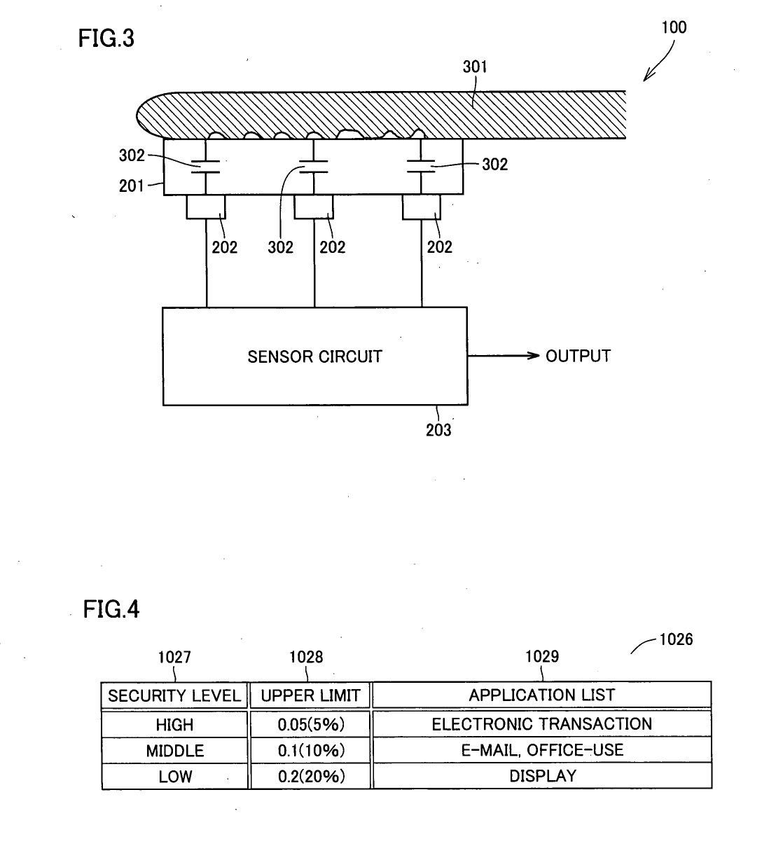

FIG. 3 shows a schematic configuration of fingerprint sensor 100. In the example shown in FIG. 3, fingerprint sensor 100 is implemented as a static-capacitance type sensor. As shown in the figure, fingerprint sensor 100 includes a sensor circuit 203, a fingerprint reading surface 201 and a plurality of electrodes 202. As shown in the figure, when a finger 301 of a user having the fingerprint as an object to be compared is placed on fingerprint reading surface 201 of fingerprint sensor 100, a capacitor 302 is formed between each of the sensor electrodes 202 and the finger 301. Here, because of irregularities of the fingerprint of finger 301 placed on reading surface 201, distance between finger 301 and each of the sensor electrodes 202 differs. Accordingly, capacitors 302 formed therebetween come to have different capacitances. Sensor circuit 203 detects the difference in capacitance among capacitors 302 based on output voltage levels of electrodes 202, and converts the difference to a voltage signal, which is amplified and output. As described above, the voltage signal output from sensor circuit 203 is a signal that corresponds to an image representing the state of irregularities of the fingerprint. As shown in the figure, fingerprint reading surface 201 is exposed to the outside, and hence it stains easily with dust or sebum. Therefore, the read image tends to contain noise components derived from the stain.

Referring to FIG. 1, memory 102 stores image data and various calculation results. Memory 102 includes a reference image memory 1021, a calculation memory 1022, a sample image memory 1023, a partial image feature value memory for reference (hereinafter referred to as reference image feature value memory) 1024, and a partial image feature value memory for a sample image (hereinafter referred to as a sample image feature value memory) 1025, and it further stores a security rank table 1026, which will be described later.

Reference image memory 1021 stores image data of a plurality of partial areas of template fingerprint images that correspond to image data to be compared with the fingerprint image data stored in sample image memory 1023. Calculation memory 1022 stores data of various calculation results. Sample image memory 1023 stores fingerprint image data output from image input unit 101. Reference image feature value memory 1024 and sample image feature value memory 1025 store data of calculation results from a partial image feature value calculating unit 1045, which will be described later.

Security rank table 1026 stores, in correspondence to a list 1029 of names of various application programs representing application processes executed in the computer shown in FIG. 2, security level data 1027 and upper limit data 1028, as shown in FIG. 4. Security level data 1027 indicates the level of security required to execute the corresponding application program identified by the name in the list 1029 as, for example, high, middle and low. Upper limit data 1028 represents the ratio of image elements that are non-eligible for comparison with respect to the image as an object of comparison, and indicates the upper limit value (maximum value) of the ratio required to execute the corresponding application program identified in the list 1029.

As shown in the figure, as the security level represented by data 1027 attains higher, the upper limit of ratio indicated by the corresponding upper limit data 1028 becomes smaller, and as the security level lowers, the upper limit value becomes larger. Therefore, it is possible to know the required security level from the ratio represented by upper limit data 1028.

The application programs and the security levels allotted thereto shown in FIG. 4 are examples and not limiting. Further, security rank table 1026 may be overwritten by an operation of input unit 700. In that case, the user may register a name of an originally developed application program with security rank table 1026 and allot a corresponding security level data 1027 and a value of upper limit data 1028 as desired.

In application list 1029, names of programs that require certain security levels at the time of execution by the computer shown in FIG. 2 are registered. What should be registered, however, is not limited to the names, and an identifier that allows identification of the program may be used. Further, it is assumed that application programs registered with application list 1029 have been stored beforehand in memory 624 or fixed disk 626. CPU 622 searches memory 624 or fixed disk 626 for the corresponding program based on the identifier registered with list 1029, reads the program and executes instructions of the program. Thus, the function of the program is attained by the computer.

Processing unit 11 includes an image correcting unit 104, a partial image feature value calculating unit (hereinafter referred to as a feature value calculating unit) 1045, a unit for determining image element not eligible for comparison (hereinafter referred to as an element determining unit) 1047, a unit for calculating ratio of image elements not eligible for comparison (hereinafter referred to as a ratio calculating unit) 1048, a unit for permitting execution of an application (hereinafter referred to as an execution permitting unit) 1049, a maximum matching score position searching unit 105, a movement-vector-based similarity score calculating unit (hereinafter referred to as a similarity score calculating unit) 106, a comparison/determination unit 107, and a control unit 108 that corresponds to CPU 622. Control unit 108 controls operations of other units. The function of each unit in processing unit 11 is realized when the corresponding program is executed. These programs are stored in advance in memory 624 or fixed disk 626, and when read and executed by CPU 622, corresponding functions are realized.

Image correcting unit 104 makes density correction of fingerprint image data.

Feature value calculating unit 1045 receives as an input given fingerprint image data, and for each of a plurality of partial area images set in the image represented by the input image data, calculates a value corresponding to a pattern of the partial image. When the fingerprint image data of interest is read from reference image memory 1021, control unit 108 stores the calculated value as the partial image feature value in reference image feature value memory 1024, and if the fingerprint image data is read from sample image memory 1023, it stores the calculated value as the partial image feature value in sample image feature value memory 1025.

Element determining unit 1047 determines (detects), from the fingerprint image to be compared, image elements to be excluded from the object of comparison. Specifically, by searching sample image feature value memory 1025, feature value of each partial image of the fingerprint image is read, and based on combinations of read feature values, a partial image to be excluded from the object of comparison (hereinafter referred to as a non-eligible element) is determined.

Ratio calculating unit 1048 calculates the ratio of partial image or images determined to be non-eligible elements relative to the entire fingerprint image to be compared. In other words, the ratio of the number of partial images occupied by the elements determined to be non-eligible by element determining unit 1047 relative to the total number of partial images set in the fingerprint image is calculated.

Execution permitting unit 1049 searches application list 1029 based on an identifier of an application (application of which activation is desired) designated beforehand by a user through input unit 700, and determines whether the identifier of the application is registered in application list 1029 or not, based on the search result. If it is determined that the identifier is registered, whether activation (execution) of the designated application program is to be permitted or inhibited (activation not permitted) is determined based on the ratio calculated by ratio calculating unit 1048.

Here, to “activate an application program” means that an operation starts to read an instruction of a program stored in advance in a memory by CPU 622 and to execute the read instruction. Further, “activation of an application program is not permitted” means the application program is locked in a software manner. Thus, activation of the application program is inhibited.

Maximum matching score position searching unit 105 receives as an input the determination result output from element determining unit 1047, and based on the input determination result, limits (determines) a partial image or partial images to be the object of comparison, from the plurality of partial images set in the fingerprint image. In accordance with the feature values of the plurality of partial images of the fingerprint image of interest calculated by feature value calculating unit 1045, the scope of search is reduced (limited). Template matching is executed in the reduced scope. Specifically, a plurality of partial areas of one of the two fingerprint images to be compared are each used as a template, a position in the other fingerprint image that attains to the highest score of matching with the template is searched, and the data representing the searched maximum matching score position is output. The output data of the maximum matching score position is stored in calculation memory 1022.

Similarity score calculating unit 106 reads the data of maximum matching score position from calculation memory 1022, and based on the read data, calculates a similarity score based on a movement vector, which will be described later. The calculated data of similarity score is stored in calculation memory 1022.

Comparison/determination unit 107 reads the data of similarity score calculated by similarity score calculating unit 106 from calculation memory 1022, and based on the similarity score represented by the read data, determines whether the two fingerprint images to be compared match (come from the same fingerprint) or do not match (come from different fingerprints).

The process for comparing two fingerprint images and controlling whether execution of an application is to be permitted or not based on the result of comparison performed in processing apparatus 1 having authentication function shown in FIG. 1 will be described with reference to the flowchart of FIG. 3. Here, for simplicity of description, images “A” and “B” are assumed to be the two fingerprint images to be compared with each other. Though images “A” and “B” as well as the partial images are shown as rectangular images, the shape of images is not limited thereto.

Further, it is assumed that at the time of inputting the fingerprint image, a finger of a user is placed beforehand in contact with fingerprint reading surface 201 of fingerprint sensor 100 (in a manner allowing reading of the fingerprint), as shown in FIG. 3. It is assumed that the user has already input the identifier of the application of which execution (activation) by the computer of FIG. 2 is desired, through input unit 700.

Further, the user registers (stores or enrolls) a reference image “A” of his/her fingerprint with reference memory 1021 in advance. Specifically, the user inputs a reference image enroll instruction by an operation of input unit 700, then CPU 622 (control unit 108) transmits a signal instructing start of an image input to image input unit 101, and waits until an image input end signal is received. Image input unit 101 reads (detects) the fingerprint of the finger placed on fingerprint reading surface 201 of fingerprint sensor 100, receives as an input the read fingerprint image as image “A”, and stores the input data of image “A” in a prescribed address of reference image memory 1021 through data bus 103. After the data of image “A” is stored in reference image memory 1021, image input unit 101 transmits the image input end signal to control unit 108. Thus, enrollment of an image as the reference image is completed. The enrolled image “A” is used as one of the images compared in the comparing process for user authentication.

At the time of enrolling the reference image, it is assumed that fingerprint reading surface 201 of fingerprint sensor 100 was not stained at all, and that the fingerprint could be read on the entire area of the fingerprint reading surface. Accordingly, it is assumed that the fingerprint represented by image “A” is free of any stain or scratch, and the fingerprint is clear.

After completion of enrollment of reference image “A”, when the user instructs start of execution of the desired program and inputs the name of the program as an identifier of the desired program through operations of input unit 700, CPU 622 (control unit 108) starts the process of FIG. 5. It is assumed that a finger of the user is placed on fingerprint reading surface 201 of fingerprint sensor 100, allowing reading of the fingerprint. The finger is the same as the finger used at the time of enrollment of the reference image.

At the start of the process shown in FIG. 5, control unit 108 transmits an image input start signal to image input unit 101, and thereafter waits until receiving an image input end signal.

Image input unit 101 reads (detects) the fingerprint of the finger placed on fingerprint reading surface 201 of fingerprint sensor 100, receives as an input image “B” the read fingerprint image, and stores the data of the input image “B” at a prescribed address of memory 102 through bus 103 (step T1). In the present embodiment, after the data of image “B” is stored in memory 102, image input unit 101 transmits an image input end signal to control unit 108.

Receiving the image input end signal, control unit 108 transmits an image correction start signal to image correcting unit 104, and thereafter waits until receiving an image correction end signal. Generally, the input image has uneven image quality, as tones of pixels and overall density distribution vary because of variations in characteristics of image input unit 101 and fingerprint sensor 100, dryness of finger skin (amount of sebum) or pressure with which fingers are pressed on the reading surface.

Receiving the instruction signal to start image correction, image correcting unit 104 corrects the image quality of the input image to suppress variations in image quality derived from different conditions under which the image is input (step T2). Specifically, images “A” and “B” stored in reference memory 1021 and sample image memory 1023 of memory 102 are read, and on each of the read image data, for the overall image corresponding to the image data or each of the small areas into which the image is divided, histogram planarization, as described in Computer GAZOU SHORI NYUMON (Introduction to computer image processing), SOKEN SHUPPAN, p. 98, or image thresholding (binarization), as described in Computer GAZOU SHORI NYUMON (Introduction to computer image processing), SOKEN SHUPPAN, pp. 66-69, is performed. Then, processed image data are stored in reference image memory 1021 and sample image memory 1023. Therefore, it follows that at this time point reference images “A” and sample images “B” before and after correction are both stored in reference image memory 1021 and sample image memory 1023.

Here, every time a sample image “B” is input, image correcting process is repeated on reference image “A” to generate a corrected reference image. The following approach, however, is also available. Specifically, as reference image “A” is input and stored in reference image memory 1021, the reference image “A” may be corrected by image correcting unit 104 and data of the corrected reference image data may also be stored in reference image memory 1021. In that case, the operation of repeating the image correcting process on reference image “A” every time a sample image “B” is input can be omitted.

After the end of image correcting process on images “A” and “B”, image correcting unit 104 transmits the image correction end signal to control unit 108.

Thereafter, for the images “A” and “B” that have been image-corrected by image correcting unit 104, feature values of partial images are calculated by feature value calculating unit 1045 (step T2a).

(Calculation of Partial Image Feature Value)

Next, the procedure of calculating the feature value of a partial image at step T2a will be described.

### Three Types of Feature Values

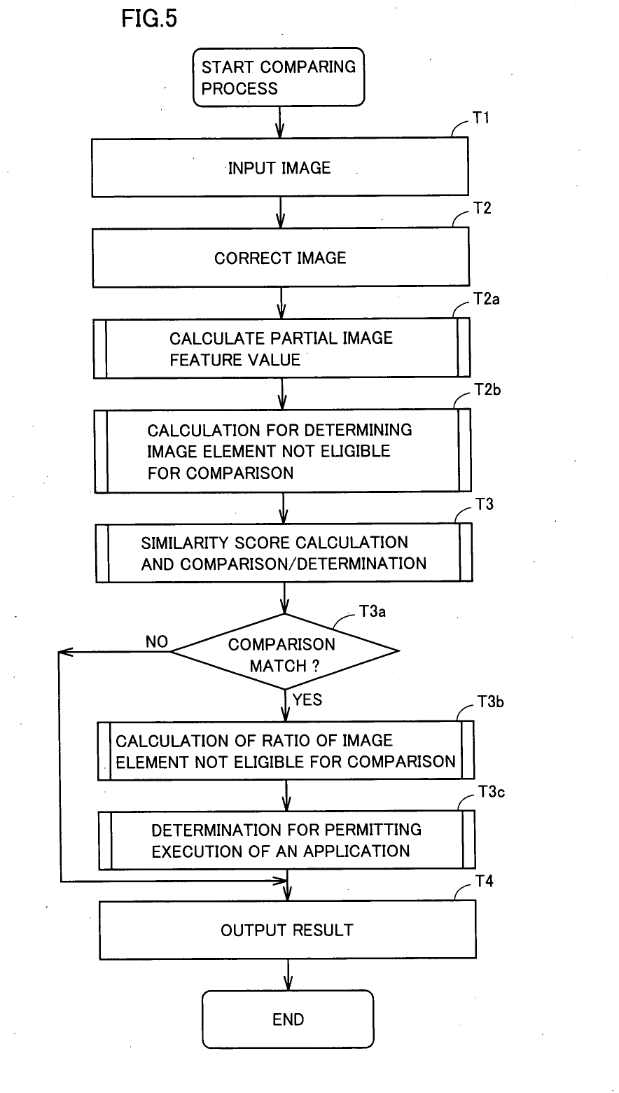

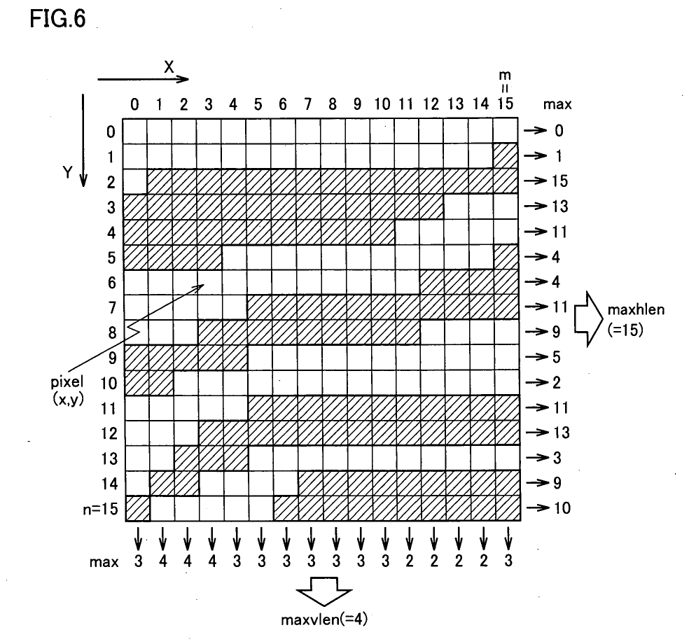

First, an example will be described in which three different feature values are used. FIG. 6 shows partial images of images “A” and “B” as the objects of comparison, with the maximum number of pixels in the horizontal and vertical directions. Here, images “A” and “B” are assumed to be rectangular two-dimensional images corresponding to two-dimensional coordinate space defined by orthogonal X and Y axes. In FIG. 6, a partial image consists of 16 pixels both in the horizontal direction along the X axis and in the vertical direction along the Y direction, that is, 16 pixels×16 pixels.

In the calculation of the partial image feature value in accordance with Embodiment 1, a value corresponding to the pattern of the partial image on which the calculation is performed is output as the partial image feature value. Specifically, the maximum number of consecutive black pixels in the horizontal direction “maxhlen” and the maximum number of consecutive black pixels in the vertical direction “maxvlen” are detected, and comparison is made between the detected maximum number of consecutive black pixels in the horizontal direction “maxhlen” (a value indicating the degree of tendency of the pattern to extend in the horizontal direction (such as horizontal stripe)) and the maximum number of consecutive black pixels in the vertical direction “maxvlen” (a value indicating the degree of tendency of the pattern to extend in the vertical direction (such as vertical stripe)). As a result of comparison, if it is determined that the number along the horizontal direction is relatively larger, a value “H” representing “horizontal” (horizontal stripe) is output. If it is determined to be the vertical direction, a value “V” representing “vertical” (vertical stripe) is output, and otherwise, “X” is output.

Referring to FIG. 6, the maximum number of consecutive black pixels “maxhlen” represents the maximum number of black pixels among the number of consecutive black (hatched in the figure) pixels detected for each of 16 rows, the is, n=0 to 15, along the horizontal direction. The number of consecutive black pixels detected along the row refers to the maximum number of consecutive black pixels detected from portions where there are one or more black pixels, of the row of interest. Further, the maximum number of consecutive black pixels “maxvlen” represents the maximum number of black pixels among the number of consecutive black (hatched in the figure) pixels detected for each of 16 columns, that is, m=0 to 15, along the vertical direction. The number of consecutive black pixels detected along the column refers to the maximum number of consecutive black pixels detected from portions where there are one or more black pixels, of the column of interest.

Even when the determined value is “H” or “V”, “X” is output, if it is determined that each of the maximum numbers of consecutive black pixels “maxhien” and “maxvlen” is not equal to or larger than the lower limit value “hlen0” or “vlen0” that is set in advance for both directions. These conditions can be given by the following expressions. If maxhlen>maxvlen and maxhlen≧hlen0, then “H” is output. If maxvlen>maxhlen and maxvlen≧vlen0, then “V” is output. Otherwise, “X” is output.

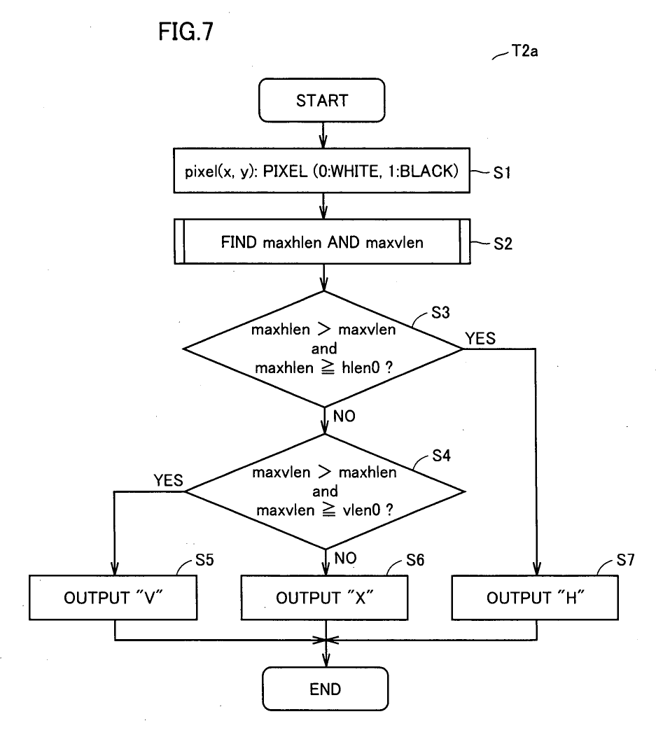

FIG. 7 shows a flowchart of the process for calculating the partial image feature value in accordance with Embodiment 1 of the present invention. The process flow is repeated for partial images “Ri” that are “N” partial area images of the reference image stored in reference memory 1021 that is an image on which the calculation is performed, and the resultant calculated values are stored, in reference image feature value memory 1024, in correspondence with respective partial images “Ri”. Similarly, the process flow is repeated for “n” partial images “Ri” of the sample image “B” stored in sample image memory 1023, and the resultant calculated values are stored, in sample image feature value memory 1025, in correspondence with respective partial images “Ri”.

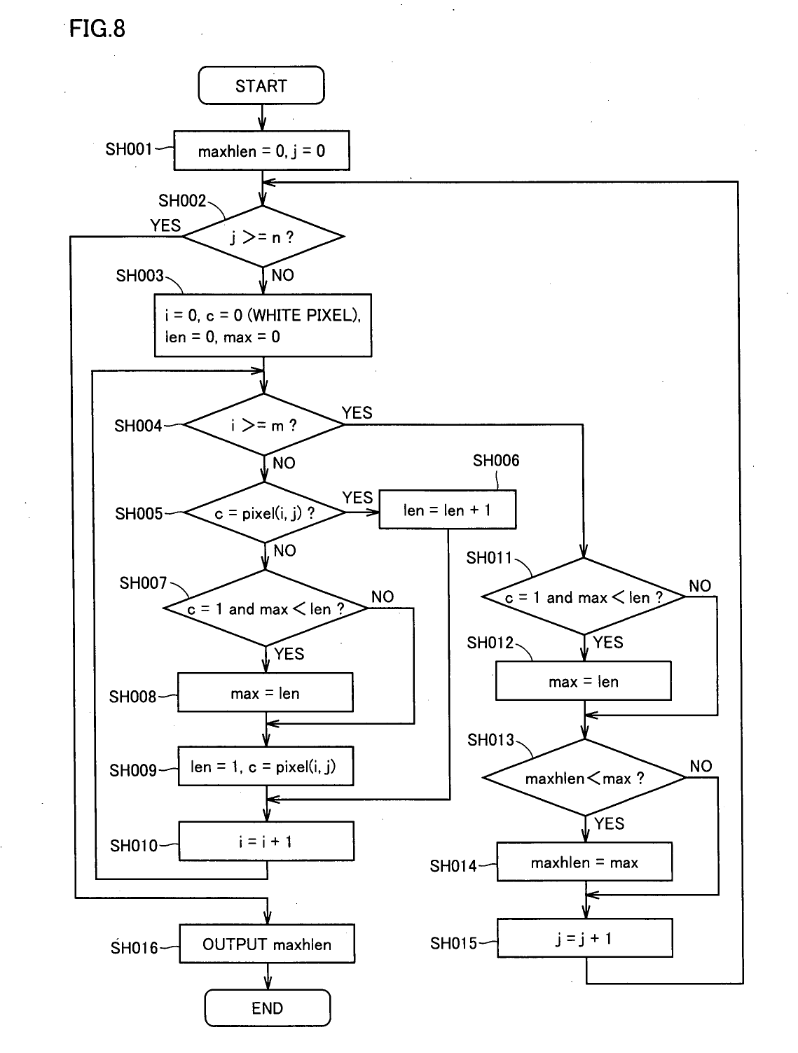

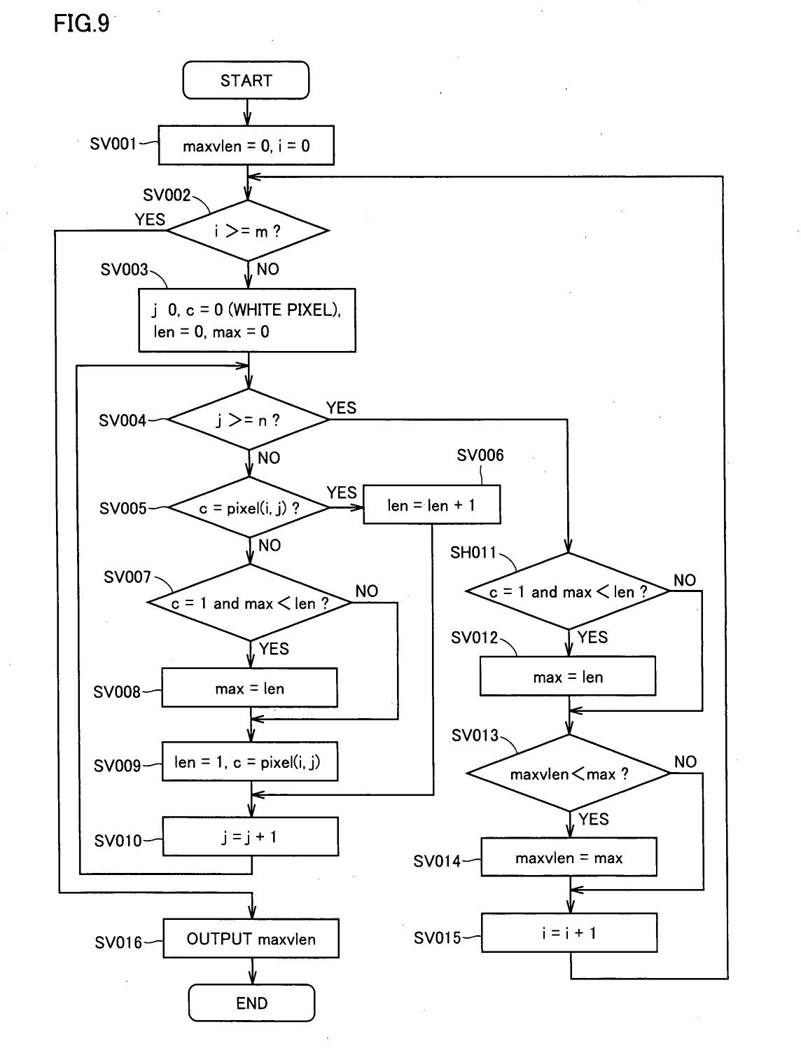

Control unit 108 transmits a partial image feature value calculation start signal to feature value calculating unit 1045, and thereafter waits until receiving a partial image feature value calculation end signal. Feature value calculating unit 1045 reads the data of partial image “Ri” on which calculation is performed from reference memory 1021 or from sample image memory 1023, and temporarily stores the same in calculation memory 1022 (step S1). Feature value calculating unit 1045 reads the stored data of partial image “Ri”, and calculates the maximum number of consecutive black pixels in the horizontal direction “maxhlen” and the maximum number of consecutive black pixels in the vertical direction “maxvlen” (step S2). The process for calculating the maximum number of consecutive black pixels in the horizontal direction “maxhlen” and the maximum number of consecutive black pixels in the vertical direction “maxvlen” will be described with reference to FIGS. 8 and 9.

FIG. 8 is a flowchart of a process (step S2) for calculating the maximum number of consecutive black pixels in the horizontal direction “maxhlen” in the process for calculating the partial image feature value (step T2a) in accordance with Embodiment 1 of the present invention. Feature value calculating unit 1045 reads the partial image “Ri” from calculation memory 1022, and initializes the maximum number of consecutive black pixels in the horizontal direction “maxhlen” and a pixel counter “j” for the vertical direction. Namely, maxhlen=0 and j=0 (step SH001).

Thereafter, the value of pixel counter “j” for the vertical direction is compared with a variable “n” representing the maximum number of pixels in the vertical direction (step SH002). If j≧n, step SH016 is executed, and otherwise, step SH003 is executed. In Embodiment 1, the number “n” is set (stored) in advance as n=16 and, at the start of processing, j=0. Therefore, the flow proceeds to step SH003.

At step SH003, a pixel counter “i” for the horizontal direction, previous pixel value “c”, the present number of consecutive pixels “len”, and the maximum number of consecutive black pixels “max” in the present row are initialized. Namely, i=0, c=0, len=0 and max=0 (step SH003). Thereafter, pixel counter “i” for the horizontal direction is compared with the maximum number of pixels “m” in the horizontal direction (step SH004). If i≧m, step SH011 is executed, and otherwise, step SH005 is executed. In Embodiment 1, the number m=16 and, at the start of processing, “i”=0. Therefore, the flow proceeds to step SH005.

At step SH005, the previous pixel value “c” is compared with the pixel value “pixel (i, j)” at the coordinates (i, j) on which the comparison is currently performed. If c=pixel (i, j), step SH006 is executed, and otherwise, step SH007 is executed. In Embodiment 1, “c” has been initialized to “0” (white pixel) and pixel (0, 0) is “0” (white pixel) as can be seen from FIG. 6. Therefore, it is determined that c=pixel (i, j) is satisfied (Y at step SH005), and the flow proceeds to step SH006.

At step SH006, the calculation len=len+1 is performed. In Embodiment 1, “len” has been initialized to len=0, and therefore, the addition of 1 provides len=1. Thereafter, the flow proceeds to step SH010.

At step SH010, the calculation i=i+1 is performed, that is, the value “i” of the horizontal pixel counter is incremented by 1. Here, “i” has been initialized to i=0, and therefore, the addition of 1 provides i=1. Then, the flow returns to step SH004. Thereafter, with reference to FIG. 6, as the pixels in the 0th row, that is, pixel (i, 0) are all white pixels and “0”, steps SH004 to SH010 are repeated until i attains to i=15. At the time when i attains to i=16 after performing step SH010, respective values are i=16, c=0 and len=15. In this state, the flow proceeds to step SH004. As m=16 and i=16, the flow further proceeds to step SH011.

At step SH011, if the condition c=1 and max<len is satisfied, step SH012 is executed. Otherwise, the flow proceeds to step SH013. At this time, the values are c=0, len=15 and max=0. Therefore, the flow proceeds to step SH013.

At step SH013, the maximum number of consecutive black pixels “maxhlen” in the horizontal direction of previous rows is compared with the maximum number of consecutive black pixels “max” of the present row. If maxhlen<max, step SH014 is executed. Otherwise, step SH015 is executed. At this time, the values are maxhlen=0 and max=0, and therefore, the flow proceeds to step SH015.

At step SH015, the calculation j=j+1 is performed, that is, the value of pixel counter “j” for the vertical direction is incremented by 1. Since j=0 at this time, the result of the calculation is j=1, and the flow returns to SH002.

Thereafter, steps SH002 to SH015 are repeated for j=1 to 15. At the time when j attains to j=16 after step SH015 is performed, the value of pixel counter “j” for the vertical direction is compared with the maximum number of pixels “n” in the vertical direction. As a result of comparison, if j≧n, step SH016 is thereafter executed. Otherwise, step SH003 is executed. At this time, the values are j=16 and n=16, and therefore, the flow proceeds to step SH016.

At step SH016, “maxhlen” is output. As can be seen from the foregoing description and FIG. 6, the value of “max” of row “2” (y=2), namely “15” that is the maximum number of consecutive black pixels in the horizontal direction is stored as “maxhlen”. Therefore, “maxhlen=15” is output.

Next, a flowchart of the process (step S2) for calculating the maximum number of consecutive black pixels “maxvlen” in the vertical direction, in the process (step T2a) for calculating the partial image feature value in accordance with Embodiment 1 of the present invention shown in FIG. 9, will be described. It is apparent that the processes of steps SV001 to SV016 in FIG. 9 are basically the same as the processes shown in the flowchart of FIG. 8 described above, and the contents can readily be understood from the description of FIG. 8. Therefore, a detailed description of FIG. 9 will not be repeated. As a result of executing the process in accordance with the flowchart of FIG. 9, “4”, which is the value of “max” in the x direction in FIG. 6, is output as the maximum number of consecutive black pixels “maxvlen” in the vertical direction.

The subsequent processes with reference to “maxhlen” and “maxvlen” that are output through the above-described procedures will be described in detail, returning to step S3 of FIG. 7.

At step S3, “maxhlen”, “maxvlen” and a prescribed lower limit “hlen0” of the maximum number of consecutive black pixels are compared with each other. If it is determined that the conditions of maxhlen>maxvlen and maxhlen≧hlen0 are satisfied (Y at step S3), step S7 is executed. If it is determined that the conditions are not satisfied (N at step S3), step S4 is executed. Here, it is assumed that maxhlen=14 and maxvlen=4 and further it is assumed that the lower limit value hlen0 is 2, and hence the conditions are satisfied. Thus, the flow proceeds to step S7. At step S7, “H” is stored in the feature value storing area of the partial image “Ri” for the original image of reference image feature value memory 1024 or sample image feature value memory 1025, and a partial image feature value calculation end signal is transmitted to control unit 108.

Assuming that the lower limit value hlen0 is 15, it is determined that the conditions of step S3 are not satisfied, and therefore, the process proceeds to step S4. At step S4, whether the conditions of maxvlen>maxhlen and maxvlen≧vlen0 are satisfied or not is determined. If it is determined that the conditions are satisfied (Y at step S4), the process of step S5 is executed next, and if the conditions are not satisfied, the process of step S6 is executed next.

Here, assuming that maxhlen=15, maxvlen=4 and hlen0=5, the conditions are not satisfied, and therefore, the flow proceeds to step S6. At step S6, “X” is stored in the feature value storing area of the partial image “Ri” for the original image of reference image feature value memory 1024 or sample image feature value memory 1025, and the partial image feature value calculation end signal is transmitted to control unit 108.

Assuming that the output values of step S2 are maxhlen=4 and maxvlen=10, hlen0=2 and vlen0=12, the conditions of step S3 are not satisfied, and the conditions of step S4 are not satisfied, either. Therefore, the process of step S5 is executed. At step S5, “V” is stored in the feature value storing area of the partial image “Ri” for the original image of reference image feature value memory 1024 or sample image feature value memory 1025, and the partial image feature value calculation end signal is transmitted to control unit 108.

As described above, feature value calculating unit 1045 in accordance with Embodiment 1 extracts (specifies) each of pixel strings in the horizontal and vertical directions of the partial image “Ri” of the image on which the calculation is performed (see FIG. 6) and, based on the number of consecutive black pixels in each extracted string of pixels, determines whether the pattern of the partial image has a tendency to extend in the horizontal direction (for example, tendency to be horizontal stripes) or a tendency to extend in the vertical direction (for example, tendency to be vertical stripes) or neither of these, so as to output a value corresponding to the result of the determination (any of “H”, “V” and “X”). The output value represents the feature value of the partial image. Although the feature value is calculated here based on the number of consecutive black pixels, the feature value may be calculated in a similar manner based on the number of consecutive white pixels.

### Another Example of Three Types of Feature Values

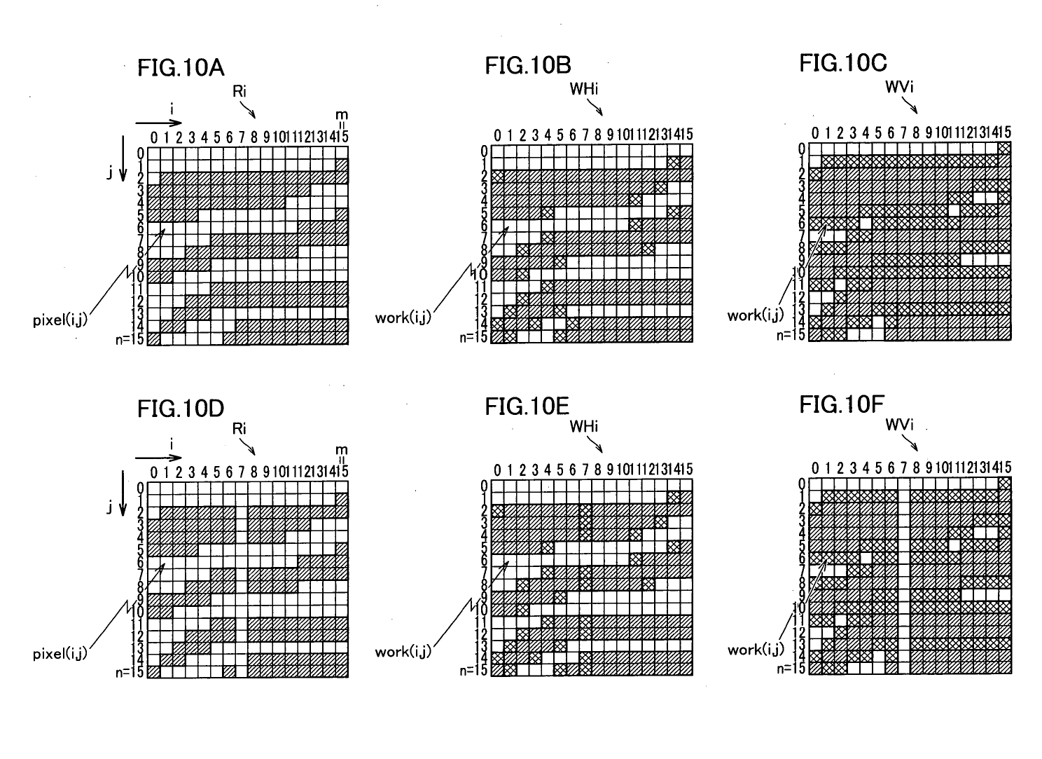

Another example of the three types of partial image feature values will be described. Outline of the partial image feature value calculation for this purpose will be described with reference to FIGS. 10A to 10F. FIGS. 10A to 10F show partial image “Ri” with the indication for example of the total number of black pixels and white pixels. In these drawings, partial image “Ri” consists of a partial area of 16 pixels×16 pixels, with 16 pixels in each of the horizontal and vertical directions. In FIGS. 10A to 10F, each partial image represents a two-dimensional image corresponding to two-dimensional coordinate space defined by orthogonal X and Y axes.

Here, based on the partial image “Ri” as the object of calculation shown in FIG. 10A, an amount of increase “hcnt” of the number of black pixels when the partial image as the object of calculation is displaced to the left/right by one pixel and superposed as shown in FIG. 10B, and an amount of increase “vcnt” of the number of black pixels when the partial image as the object of calculation is displaced upward/downward by one pixel and superposed as shown in FIG. 10C are calculated. The calculated amounts of increase “hcnt” and “vcnt” are compared with each other, and if the amount of increase “hcnt” is larger than twice the amount of increase “vcnt”, the value “H” representing “horizontal” is output, and if the amount of increase “vcnt” is larger than twice the amount of increase “hcnt”, the value “V” representing “vertical” is output. FIGS. 10D to 10F similarly show other examples.

Here, the “amount of increase of the number of black pixels when the partial image as the object of calculation is displaced to the left/right by one pixel” shown in FIGS. 10A to 10C represents “difference between the total number of black pixels in an image (16×16 pixels) obtained by generating an image by displacing an original image by +1 pixel parallel to the i-axis so that coordinates (i, j) of each pixel is changed to (i+1, j), generating an image by displacing the original image by −1 pixel parallel to the i-axis so that coordinates (i, j) of each pixel is changed to (i−1, j), with the coordinates of each pixel in the original image (16×16 pixels) being (i, j), and superposing the thus generated two images on the original image with pixels of the same coordinates (i, j) match with each other, and the total number of black pixels in the original image.”

Here, the “amount of increase of the number of black pixels when the partial image as the object of calculation is displaced upward/downward by one pixel” shown in FIGS. 10D to 10F represents “difference between the total number of black pixels in an image (16×16 pixels) obtained by generating an image by displacing an original image by +1 pixel parallel to the j-axis so that coordinates (i, j) of each pixel is changed to (i, j+1), generating an image by displacing the original image by −1 pixel parallel to the j-axis so that coordinates (i, j) of each pixel is changed to (i, j−1), with the coordinates of each pixel in the original image (16×16 pixels) being (i, j), and superposing the thus generated two images on the original image with pixels of the same coordinates (i, j) match with each other, and the total number of black pixels in the original image.”

In these operations, when a black pixel is superposed on a black pixel, the pixel comes to be a black pixel, when a black pixel and a white pixel are superposed, the pixel comes to be a black pixel, and when a white pixel is superposed on a white pixel, the pixel comes to be a white pixel.

Next, details of the process for calculating the partial image feature value will be described with reference to the flowchart of FIG. 1A. The flow is repeated for “N” partial images “Ri” of reference image “A” stored in reference memory 1021 as an object of calculation, and the resultant calculated values are stored in reference image feature value memory 1024, in correspondence with respective partial images “Ri”. Similarly, the flow is repeated for “N” partial images “Ri” of sample image “B” stored in sample image memory 1023 and the resultant calculated values are stored, in sample image feature value memory 1025, in correspondence with respective partial images “Ri”.

First, control unit 108 transmits a partial image feature value calculation start signal to feature value calculating unit 1045, and thereafter waits until receiving a partial image feature value calculation end signal.

Feature value calculating unit 1045 reads partial image “Ri” (see FIG. 10A) on which the calculation is performed, from reference memory 1021 or from sample image memory 1023, and temporarily stores the same in calculation memory 1022 (step ST1). Feature value calculating unit 1045 reads the stored data of partial image “Ri”, and calculates increase “hcnt” in the case where the partial image is displaced to the left/right as shown in FIG. 10B and increase “vcnt” in the case where the partial image is displaced upward/downward as shown in FIG. 10C (step ST2).

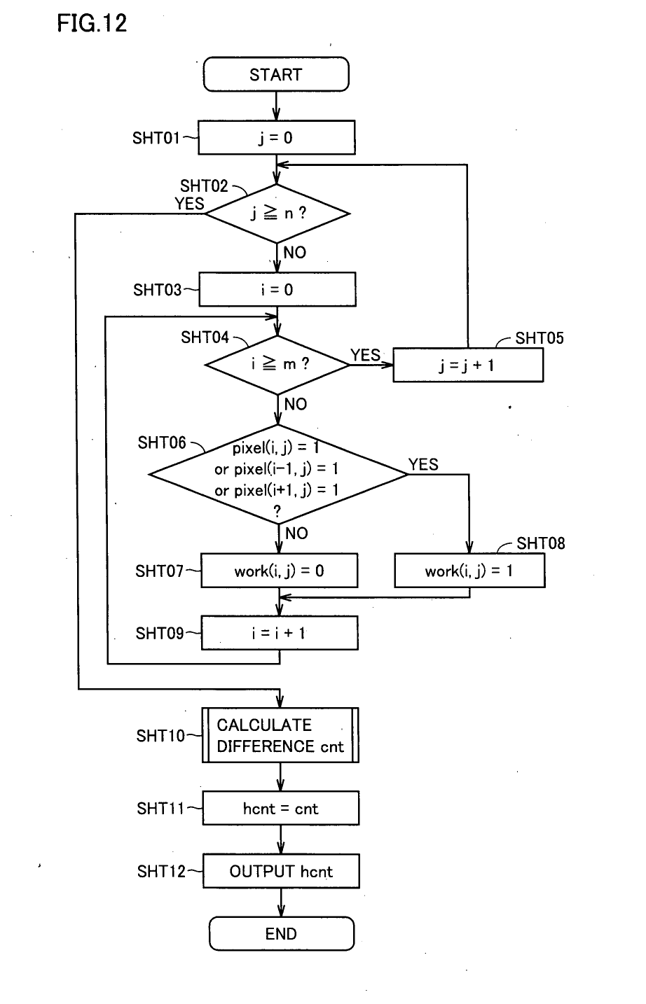

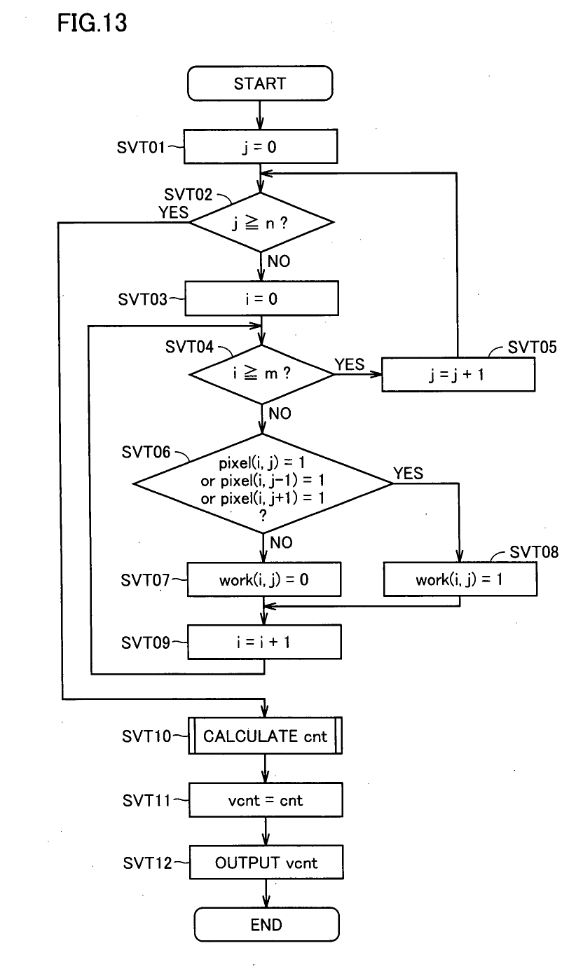

The process for detecting increase “hcnt” and increase “vcnt” will be described with reference to FIGS. 12 and 13. FIG. 12 is a flowchart of the process for obtaining the amount of increase “hcnt” (step ST2). FIG. 13 is a flowchart of the process for obtaining the amount of increase “vcnt” (step ST2).

Referring to FIG. 12, feature value calculating unit 1045 reads partial image “Ri” from calculation memory 1022 and initializes the value of counter “j” for the pixels in the vertical direction, namely j=0 (step SHT01). Thereafter, the value of counter “j” for the vertical direction is compared with the maximum number “n” of pixels in the vertical direction (step SHT02). If j>n, step SHT10 is executed next, and otherwise, step SHT03 is executed next. Here, n=16 and j=0 at the start of processing, and therefore, the flow proceeds to step SHT03.

At step SHT03, the value of counter “i” for the pixels in the horizontal direction is initialized, namely i=0. Thereafter, the value of counter “i” for the horizontal direction is compared with the maximum number of pixels “m” in the horizontal direction (step SHT04). If i>m, step STH05 is executed next, and otherwise, step SHT06 is executed. Here, m=16 and i=0 at the start of processing, and therefore, the flow proceeds to SHT06.

At step SHT06, partial image “Ri” is read and it is determined whether pixel value “pixel (i, j)” at coordinates (i, j) in the partial image that is the object of comparison at present is 1 (black pixel) or not, whether pixel value “pixel (i−1, j)” at coordinates (i−1, j) that is one pixel to the left of coordinates (i, j) is 1 or not, or whether pixel value “pixel (i+1, j)” at coordinates (i+1, j) that is one pixel to the right of coordinates (i, j) is 1 or not. If pixel (i, j)=1, or pixel (i−1, j)=1 or pixel (i+1, j)=1, then step SHT08 is executed, and otherwise, step SHT07 is executed.

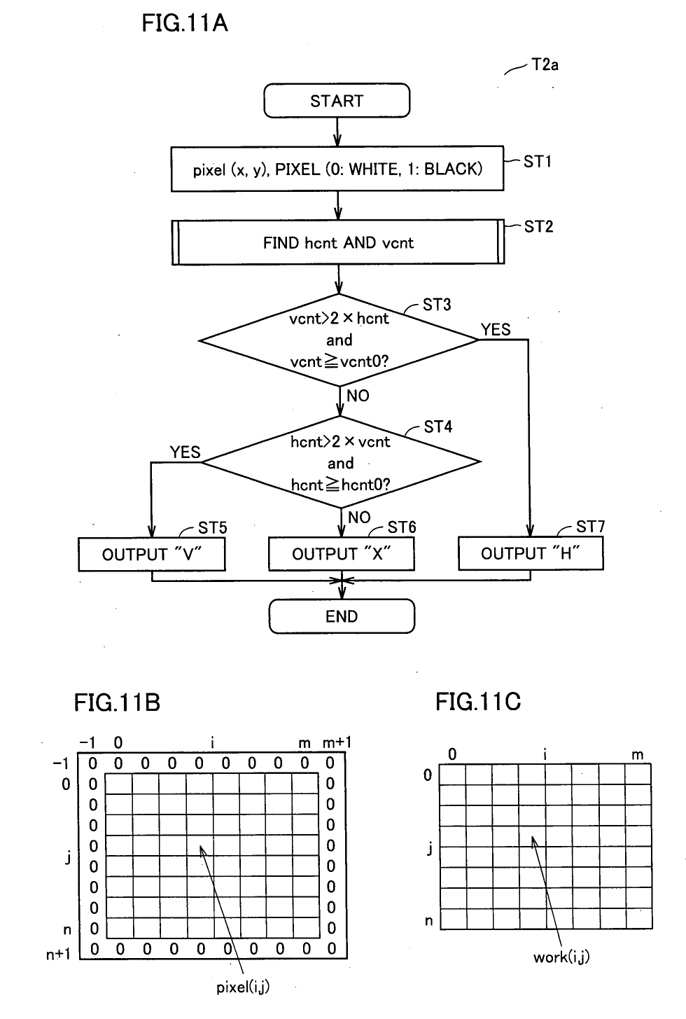

Here, it is assumed that pixel values in the scope of one pixel above, one pixel below, one pixel to the left and one pixel to the right of partial image “Ri”, that is, the range of Ri (−1 to m+1, −1), Ri (−1, −1 to n+1), Ri (m+1, −1 to n+1) and Ri (−1 to m+1, n+1) are all “0” (white pixel), as shown in FIG. 11B. Here, with reference to partial image “Ri” in FIG. 10A, pixel (0, 0)=0, pixel (−1, 0)=0 and pixel (1, 0)=0, and therefore, the flow proceeds to step SHT07.

At step SHT07, “0” is stored as pixel value work (i, j) at coordinate (i, j) of image “WHi” (see FIG. 11C), obtained by superposing images displaced to the left and right by one pixel, stored in calculation memory 1022. Specifically, work (0, 0)=0. Then, the flow proceeds to step SHT09.

At step SHT09, the value of counter “i” for pixels in the horizontal direction is incremented by 1, that is, i=i+1. Here, the value has been initialized as i=0, and by the addition of 1, the value attains to i=1. Then, the flow returns to step SHT04. As the pixels in the 0-th row, that is, pixel (i, 0) are all white pixels as shown in FIG. 10A and thus the pixel value is 0, steps SHT04 to SHT09 are repeated until “i” attains to i=15. Then, after step SHT09, “i” attains to i=16. In this state, the flow proceeds to step SHT04. As m=16 and i=16, the flow proceeds to step SHT05.

At step SHT05, the value of counter “j” for pixels in the vertical direction is incremented by 1, that is, j=j+1. At present, j=0, and therefore, the increment generates j=1, and the flow returns to step SHT02. Here, it is the start of a new row, and therefore, as in the 0-th row, the flow proceeds though steps SHT03 and SHT04. Thereafter, steps SHT04 to SHT09 are repeated until the pixel of the first row and 14-th column, that is, i=14, j=1 having the pixel value of pixel (i+1, j)=1 is reached. After the process of step SHT09, the value i attains to i=14. As m=16 and i=14, the flow proceeds to step SHT06.

At step SHT06, pixel (i+1, j)=1, namely, pixel (14+1, 1)=1, and therefore, the flow proceeds to step SHT08.

At SHT08, 1 is stored, in calculation memory 1022, as pixel value work (i, j) at coordinates (i, j) of image “WHi” (see FIG. 10B) obtained by superposing images displaced by one pixel to the left and right.

The flow proceeds to step SHT09, where i attains to i=16, and the flow proceeds to step SHT04. In that case, m=16 and i=16, and therefore, the flow proceeds to step SHT05, where j attains to j=2. Then, the flow proceeds to step SHT02. Thereafter, the processes of steps SHT02 to SHT09 are repeated for j=2 to 15. When value “j” attains to j=16 after step SHT09, the flow proceeds to step SHT02 where the value of counter “j” is compared with the maximum pixel number “n” in the vertical direction. If j≧n, step SHT10 is executed next, and otherwise, step SHT03 is executed. At present, j=16 and n=16, and therefore, the flow proceeds to step SHT10. At this time, in calculation memory 1022, based on partial image “Ri” shown in FIG. 10A on which the calculation is now being performed, the image “WHi” obtained by superposing images displaced by 1 pixel to the left and right, such as shown in FIG. 10B, is stored.

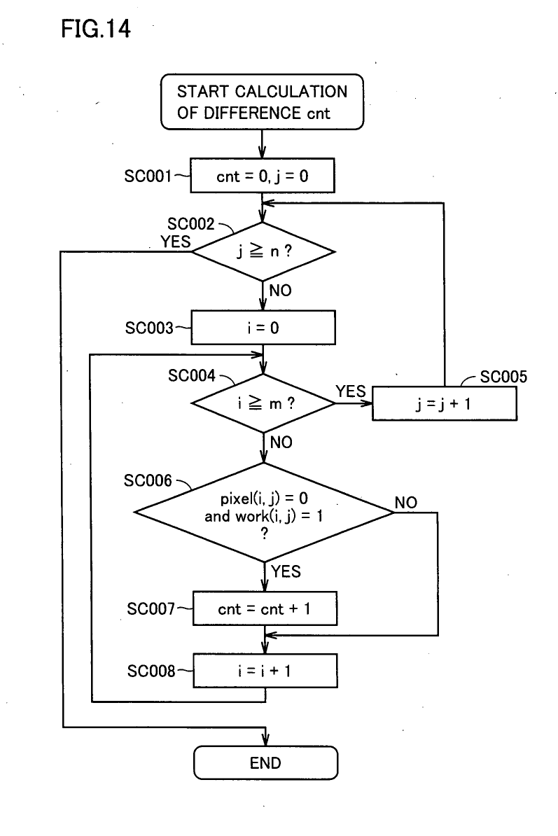

At step SHT10, difference “cnt” between each pixel value work (i, j) of image “WHi” obtained by superposing images displaced by 1 pixel to the left and right and stored in calculation memory 1022 and each pixel value pixel (i, j) of partial image “Ri” that is compared and collated at present is calculated. The process for calculating difference “cnt” between “work” and “pixel” will be described with reference to FIG. 14.

FIG. 14 is a flowchart showing the calculation of difference “cnt” between pixel value pixel (i, j) of partial image “Ri” that is compared and collated at present and pixel value work (i, j) of image “WHi” obtained by superposing images obtained by displacing partial image “Ri” by 1 pixel to the left and to the right. Feature value calculating unit 1045 reads partial image “Ri” and image “WHi” obtained by superposing the images displaced by 1 pixel from calculation memory 1022, and initializes difference counter “cnt” and the value of counter “j” for the pixels in the vertical direction, that is, cnt=0 and j=0 (step SC001). Thereafter, the value of counter “j” for the vertical direction is compared with the maximum number of pixels “n” in the vertical direction (step SC002). If j≧n, the flow returns to the process shown in FIG. 12, step SHT11 is executed in which “cnt” is input to “hcnt”, and otherwise, step SC003 is executed next.

Here, n=16, and at the start of processing, j=0. Therefore, the flow proceeds to step SC003. In step SC003, the value of pixel counter “i” for the horizontal direction is initialized, namely i=0. Thereafter, the value of counter “i” for the horizontal direction is compared with the maximum number of pixels “m” in the horizontal direction (step SC004), and if i>m, step SC005 is executed next, and otherwise, step SC006 is executed. Here, m=16, and i=0 at the start of processing, and therefore, the flow proceeds to SC006.

At step SC006, it is determined whether or not pixel value pixel (i, j) at coordinates (i, j) of partial image “Ri”, which is the object of comparison at present, is 0 (white pixel) and pixel value work (i, j) of image “WHi” obtained by superposing images displaced by 1 pixel is 1 (black pixel). If pixel (i, j)=0 and work (i, j)=1, step SC007 is executed next, and otherwise, step SC008 is execute next. Here, pixel (0, 0)=0 and work (0, 0)=0, as shown in FIGS. 10A and 10B, and therefore, the flow proceeds to step SC008.

At step SC008, the value of counter “i” for the horizontal direction is incremented by 1, that is, i=i+1. Here, the value has been initialized to i=0, and the addition of 1 provides i=1. Then, the flow returns to step SC004. As the subsequent pixels of the 0-th row, namely pixel (i, 0) and work (i, 0) are all white pixels and the value is 0 as shown in FIGS. 10A and 10B, steps SC004 to SC008 are repeated until the value i attains to i=15. After step SC008 at which i=16 is satisfied, the values are cnt=0 and i=16. In this state, the flow proceeds to step SC004. Since m=16 and i=16, the flow proceeds to step SC005.

At step SC005, the value of counter “j” for the vertical direction is incremented by 1, that is, j=j+1. At present, j=0, and therefore, the value j attains to j=1, and the flow returns to step SC002. Here, it is the start of a new row, and therefore, as in the 0-th row, the flow proceeds to steps SC003 and SC004. Thereafter, steps SC004 to SC008 are repeated until the pixel of the first row and 14-th column, that is, i=15, j=1 is reached, and after the process of step SC008, the value “i” attains to i=15. Here, m=16 and i=15, and the flow proceeds to SC006.

At step SC006, the pixel values are determined as pixel (i, j)=0 and work (i, j)=1, that is, it is determined that pixel (14, 1)=0 and work (14, 1)=1, so that the flow proceeds to step SC007.

At step SC007, the value of difference counter “cnt” is incremented by 1, that is, cnt=cnt+1. Here, the value has been initialized to cnt=0 and the addition of 1 generates cnt=1. Next, the flow proceeds to step SC008, where “i” attains to i=16, and then the flow proceeds to step SC004. Since m=16 and i=16, the flow proceeds to step SC005, where j attains to j=2, and the flow proceeds to step SC002.

Thereafter, the process of steps SC002 to SC009 is repeated while j=2 to 15, and when the value j attains to j=15 after the process of step SC008, the flow proceeds to step SC002, in which the value of counter “j” for the vertical direction is compared with the maximum number of pixels “n” in the vertical direction. If j≧n, the flow returns to the flowchart of FIG. 12, and step SHT11 is executed. Otherwise, step SC003 is executed next. At present, j=16 and n=16, and therefore, the flowchart of FIG. 13 is terminated, and the flow returns to the flowchart of FIG. 12 to proceed to step SHT11. At this time point difference counter is cnt=21.

At step STH11, the value of difference “cnt” calculated in accordance with the flowchart of FIG. 13 is input as the amount of increase “hcnt” when displaced to the left/right, that is, hcnt=cnt. Then, the flow proceeds to step SHT12. In step SHT12, the amount of increase hcnt=21 when displaced to the left/right is output.

It is apparently seen that steps SVT01 to SVT12 in FIG. 13 in the process (step ST2) of determining the increase “vcnt” in the process (step T2ac) of calculating the partial image feature value of FIG. 11 are basically the same as those steps in FIG. 12 described above. Therefore, detailed description will not be repeated.

As the amount of increase “vcnt” when the image is displaced upward/downward, the difference 96 between image “WVi” in FIG. 10C obtained by displacing the image upward/downward by 1 pixel and partial image “Ri” in FIG. 10A is output.

The processes thereafter performed on the output values “hcnt” and “vcnt” will be described, returning to step ST3 and the following steps of FIG. 11.

At step ST3, increases “hcnt”, “vcnt” and the lower limit “vcnt0” of increase in maximum number of black pixels in the upward and downward directions are compared with each other. If the conditions vcnt>2×hcnt and vcnt≧vcnt0 are satisfied, step ST7 is executed next, and if the conditions are not satisfied, step ST4 is executed. At present, vcnt=96, hcntb=21, and assuming that vcntb0=4, the flow proceeds to step ST7. At step ST7, “H” is output to the feature value storage area of partial image “Ri” of the original image in reference image feature value memory 1024 or in sample image feature value memory 1025, and the partial image feature value calculation end signal is transmitted to control unit 108.

If the output values of step ST2 are “vcnt”=30, “hcnt”=20 and “vcnt0”=4, the conditions of step S3 are not satisfied, and then the flow proceeds to step ST4. At step S4, when it is determined that the conditions hcnt>2×vcnt and hcnt>hcntb0 are satisfied, step ST5 is executed next, and if the conditions are not satisfied, step ST6 is executed.

Here, the flow proceeds to step ST6, in which “X” is output to the feature value storage area of partial image “Ri” of the reference image feature value memory 1024 or sample image feature value memory 1025, and the partial image feature value calculation end signal is transmitted to control unit 108.

When the output values of step ST2 are “vcnt”=30, “hcnt”=70 and “vcnt0”=4, then in step ST3, it is determined that conditions vcnt>2×hcnt and vcnt≧vcnt0 are not satisfied. Then, step ST4 is executed. At step ST4, whether the conditions that hcnt>2×vcnt and hcnt≧hcnt0 are satisfied is determined. If the conditions are satisfied, step ST5 is executed next, and if the conditions are not satisfied, step ST6 is executed next.

Here, it is determined that the conditions are satisfied, the flow proceeds to step ST5, and “V” is output to the feature value storage area of the partial image “Ri” of the reference image feature value memory 1024 or sample image feature value memory 1025, and the partial image feature value calculation end signal is transmitted to control unit 108.

Regarding the partial image feature value calculation, assume that the reference image or the sample image has noise. By way of example, assume that the fingerprint image as the reference image “A” or sample image “B” is partially missing because of a furrow for example of the finger and as a result, the partial image “Ri” has a vertical crease at the center as shown in FIG. 10D. In such a case, as shown in FIGS. 10E and 10F, the increases are hcnt=29 and vcnt=90. Then, if vcnt0=4 is set, at step ST3 of FIG. 11, vcnt>2×hcnt and vcnt≧vcnt0 are satisfied and step ST7 is executed. Here, value “H” representing “horizontal” is output. Namely, the calculation of partial image feature value has a characteristic that maintains calculation accuracy against noise components included in the image.

As described above, feature value calculating unit 1045 generates image “WHi” by displacing partial image “Ri” leftward and rightward by a prescribed number of pixels and superposing the resulting images, and image “WVi” by displacing the partial image “Ri” upward and downward by a prescribed number of pixels and superposing the resulting images, determines the increase of black pixels “hcnt” as a difference in number of black pixels between partial image “Ri” and image “WHi” and determines the increase of black pixels “vcnt” as a difference in number of black pixels between partial image “Ri” and image “WVi”. Then, based on these increases, it is determined that the pattern of partial image “RI” has a tendency to extend in the horizontal direction (tendency to be horizontal stripe) or a tendency to extend in the vertical direction (tendency to be vertical stripe) or does not have any such tendency, and the value representing the result of the determination (any of “H”, “V” and “X”) is output. The output value is the feature value of the partial image “Ri”.

### Another Example of Three Types of Feature Values

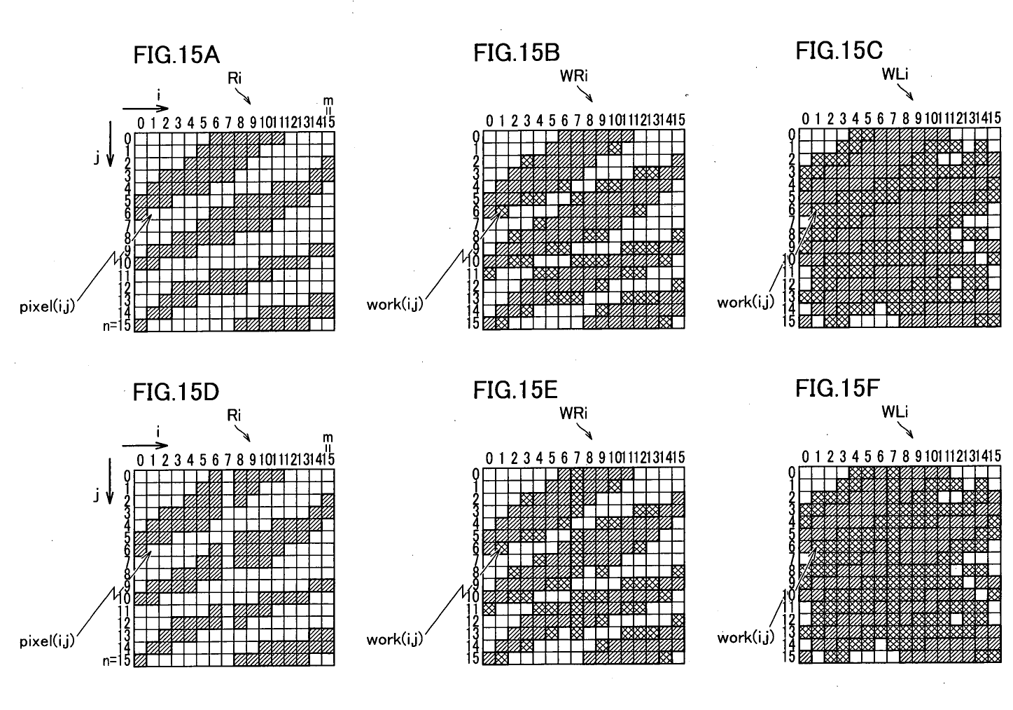

The three types of partial image feature values are not limited to those described above, and the following three different types may be used. An outline of partial image feature value calculation for that purpose will be described with reference to FIGS. 15A to 15F. FIGS. 15A to 15F show the partial image “Ri” together with the total number of black pixels and white pixels for example. In these figures, partial image “Ri” is comprised of partial areas of 16 pixels×16 pixels with 16 pixels in each of the horizontal and vertical directions. The calculation of the partial image feature value is performed in the following manner. Partial image “Ri” in FIG. 15A as the object of calculation is displaced in the upper right oblique direction by one pixel, superposed on the original image and the amount of increase “rcnt” of the number of black pixels (hatched portion of image WHi″ of FIG. 15B) is calculated, and partial image “Ri” is also displaced in the lower right oblique direction by one pixel, superposed on the original image and the amount of increase “lcnt” of the number of black pixels (hatched portion of image WVi″ of FIG. 15C) is calculated, and the calculated amounts of increase “rcnt” and “lcnt” are compared. If the amount of increase “lcnt” is larger than twice the increase “rcnt”, value “R” representing “right oblique” is output. When increase “rcnt” is larger than twice the increase “lcnt”, value “L” representing “left oblique” is output. Otherwise, value “X” is output.

The “amount of increase of the number of black pixels when the image is displaced in the right oblique direction by one pixel and superposed” means the “difference between the total number of black pixels in an image (16×16 pixels) obtained by generating an image by displacing an original image so that coordinates (i, j) of each pixel is changed to (i+1, j−1), generating an image by displacing the original image so that coordinates (i, j) of each pixel is changed to (i−1, j+1), with the coordinates of each pixel in the original image (16×16 pixels) being (i, j), and superposing the thus generated two images on the original image with pixels of the same coordinates (i, j) match with each other, and the total number of black pixels in the original image.”

The “amount of increase of the number of black pixels when the image is displaced in the left oblique direction by one pixel and superposed” means the “difference between the total number of black pixels in an image (16×16 pixels) obtained by generating an image by displacing an original image so that coordinates (i, j) of each pixel is changed to (i−1, j−1), generating an image by displacing the original image so that coordinates (i, j) of each pixel is changed to (i+1, j−1), with the coordinates of each pixel in the original image (16×16 pixels) being (i, j), and superposing the thus generated two images on the original image with pixels of the same coordinates (i, j) match with each other, and the total number of black pixels in the original image.”

In these operations, when a black pixel is superposed on a black pixel, the pixel comes to be a black pixel, when a black pixel and a white pixel are superposed, the pixel comes to be a black pixel, and when a white pixel is superposed on a white pixel, the pixel comes to be a white pixel.

It should be noted here that, even if the above-described determination is “R” or “L”, “X” is output when the above-described increase in number of black pixels is not equal to or larger than the lower limit “lcnt0” or “rcnt0” set in advance for both directions. These conditions may be mathematically represented in the following way. If the conditions (1) lcnt>2×rcnt and (2) lcnt≧lcnt0 are satisfied, “R” is output. If the conditions (3) rcnt>2×lcnt and (4) rcnt≧rcnt0 are satisfied, “L” is output. Otherwise, “X” is output.

Here, the value “R” representing “right oblique” is output if the amount of increase “lcnt” is larger than twice the amount of increase “rcnt”. The value “twice” as the threshold may be changed to a different value. The same applies to the right oblique direction. Further, if it is known in advance that the number of black pixels in partial image “Ri” is in a certain range (for example, the number of black pixels in partial image “Ri” is in the range of 30% to 70% relative to the total number of black pixels) and that the image is appropriate for the comparing process, the above-described conditions (2) and (4) may not be used.

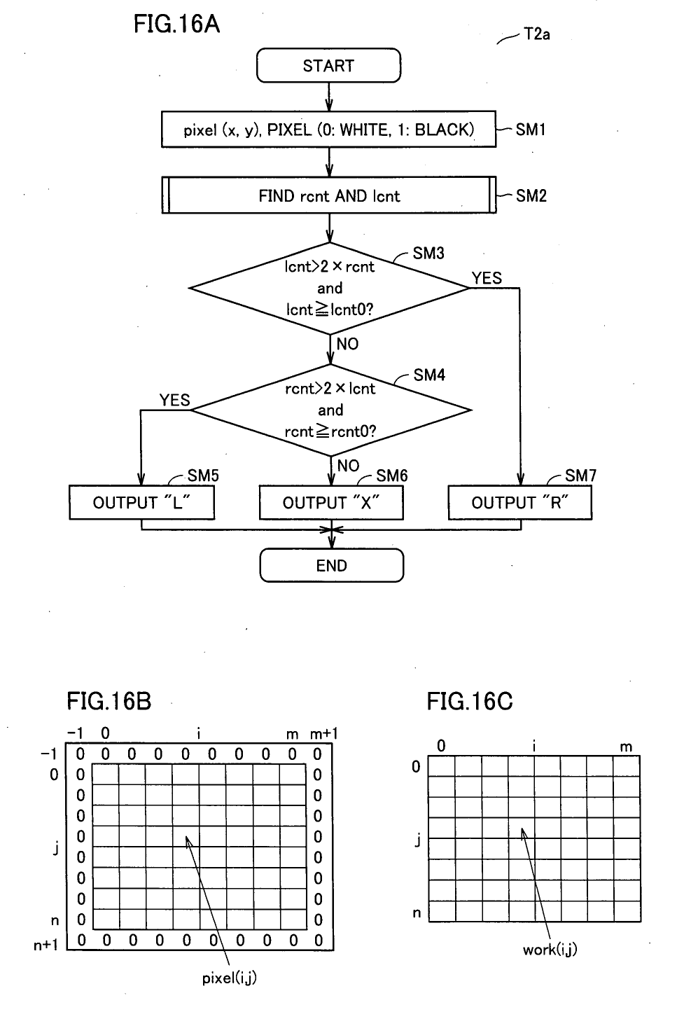

FIG. 16A is a flowchart of a still another process for calculating the partial image feature value. The flowchart is repeated for “N” partial images “Ri” of a reference image “A” as the object of calculation stored in reference image memory 1021. The result of calculation is stored in correspondence to each partial image “Ri” in reference image feature value memory 1024. Similarly, the flowchart is repeated for “N” partial images “Ri” of a sample image “B” in sample image memory 1023. The result of calculation is stored in correspondence to each partial image “Ri” in sample image feature value memory 1025. In the following, details of the feature image value calculation will be described with reference to the flowchart in FIG. 16.

Control unit 108 transmits to feature value calculating unit 1045 the partial image feature value calculation start signal and thereafter waits until receiving the partial image feature value calculation end signal.

Feature value calculating unit 1045 reads partial image “Ri” on which the calculation is to be performed (see FIG. 15A) from reference image memory 1021 or sample image memory 1023 and temporarily stores it in calculation memory 1022 (step SM1). Feature value calculating unit 1045 reads the stored partial image “Ri” to find increase “rcnt” when the partial image is displaced in the right oblique direction as shown in FIG. 15B and finds increase “lcnt” when the partial image is displaced in the left oblique direction as shown in FIG. 15C (step SM2).

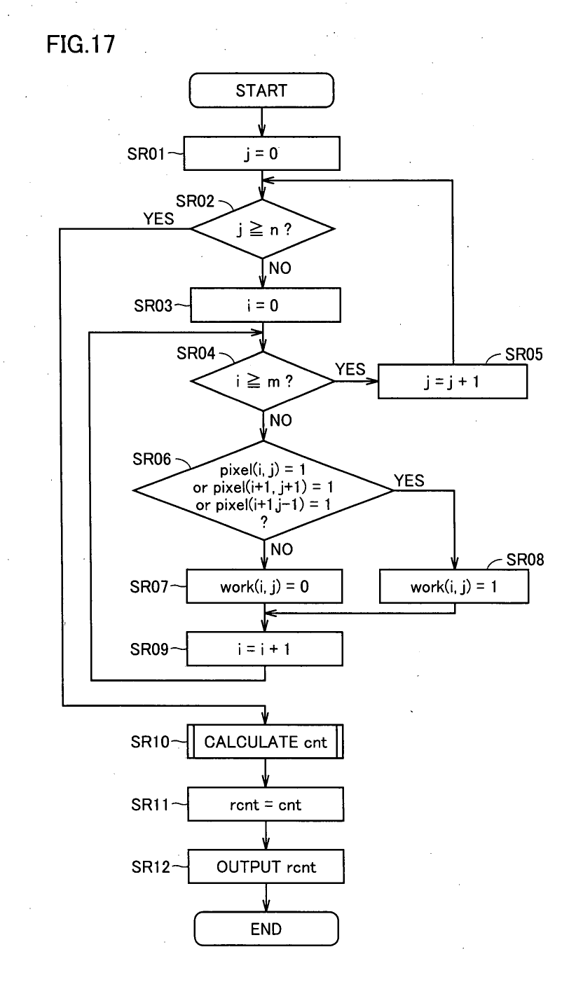

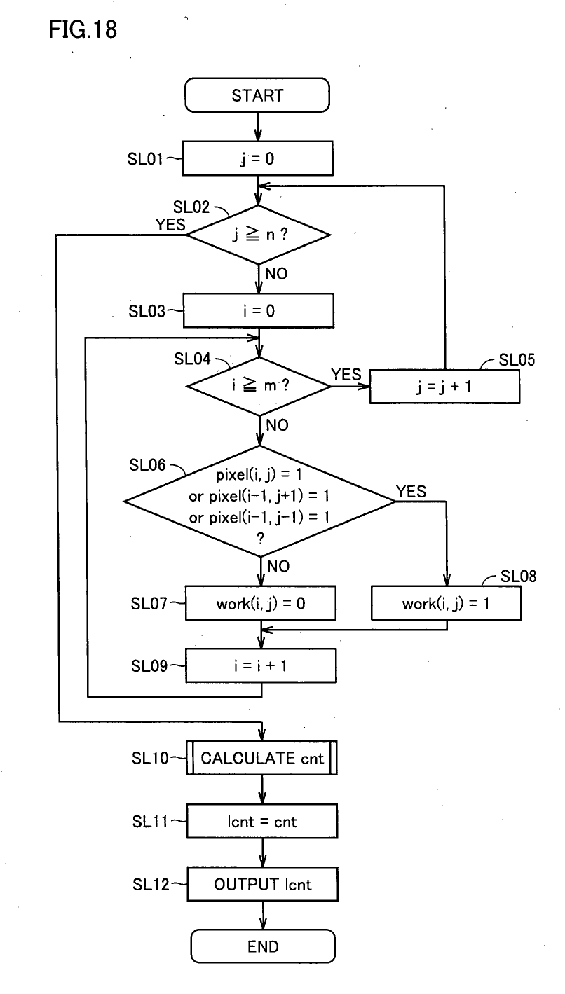

The process for finding the amounts of increase “rcnt” and “lcnt” is described with reference to FIGS. 17 and 18. FIG. 17 is a flowchart for the step (step SM2) of detecting the amount of increase “rcnt” in the step of calculating the partial image feature value (step T2a).

Referring to FIG. 17, feature value calculating unit 1045 reads partial image “Ri” from calculation memory 1022 and initializes the value of counter “j” for pixels in the vertical direction, namely j=0 (step SR01). Then, the value of counter “j” for the vertical direction and the maximum number of pixels in the vertical direction “n” are compared with each other (step SR02). When the result of comparison is j≧n, step SR10 is subsequently performed. Otherwise, step SR03 is subsequently performed. Here, n=is 16 and j=0 at the start of this process, so that the flow proceeds to step SR03.

At step SR03, the value of counter “i” for pixels in the horizontal direction is initialized, namely i=0. Then, the value of counter “i” for pixels in the horizontal direction and the maximum number of pixels in the horizontal direction “m” are compared with each other (step SR04). If result of comparison is i≧m, step SR05 is subsequently performed. Otherwise, the step SR06 is subsequently performed. Here, m=16 and i=0 at the start of the process, so that the flow proceeds to step SR06.

At step SR06, the partial image “Ri” is read, and it is determined whether the pixel value, pixel (i, j), at coordinates (i, j) on which the comparison is made at present is 1 (black pixel), or the pixel value, pixel (i+1, j+1), at the upper right adjacent coordinates (i+1, j+1) relative to coordinates (i, j) is 1, or the pixel value, pixel (i+1, j−1), at the lower right adjacent coordinates (i+1, j−1) relative to coordinates (i, j) is 1. If pixel (i, j)=1, or pixel (i+1, j+1)=1 or pixel (i+1, j−1)=1, step SR08 is subsequently performed. Otherwise, step SR07 is subsequently performed.

It is supposed here that, as shown in FIG. 16B, those pixels directly adjacent to partial image “Ri” in the upper, lower, right and left directions, namely the pixels in the range Ri (−1 to m+1, −1), Ri (−1, −1 to n+1), Ri (m+1, −1 to n+1) and Ri (−1 to m+1, n+1) have pixel value 0 (white pixels). Here, with reference to FIG. 15A, pixel values are pixel (0, 0)=0, pixel (1, 1)=0 and pixel (1, −1)=0, so that the flow proceeds to step SR07.

At step SR07, 0 is stored as the pixel value, work (i, j), at coordinates (i, j) (see FIG. 16C) in the area of image WHi obtained by superposing images displaced in the right oblique direction by one pixel and stored in calculation memory 1022. Namely work (0, 0)=0. Then, the flow proceeds to step SR09.

At step SR09, the value of counter “i” is incremented by one, namely i=i+1. Here, the value has been initialized to i=0. Therefore, the addition of 1 provides i=1. Then, the flow returns to step SR04.

At step SR05, the value of counter “j” for pixels in the vertical direction is incremented by one, namely j=j+1. At this time, j=0 and this operation provides j=

1. Then, the flow returns to SR02. Here, since the new row is processed, the flow proceeds through steps SR03 and SR04 as does for the 0-th row. After this, steps SR04 to SR09 are repeated until it reaches to the pixel of the first row and fifth column where pixel (i, j)=1, that is, i=5 and j=1. After step SR09, i=5 is attained. Since m=16 and i=5, the flow proceeds to step SR06.

At step SR06, pixel (i, j)=1, namely pixel (5, 1)=1, and the flow proceeds to step SR08.

At step SR08, 1 is stored as pixel value work (i, j) at coordinates (i, j) in image “WRi” (see FIG. 15B) obtained by superposing an image displaced in right oblique direction by one pixel, and stored in calculation memory 1022, namely, work (5, 1)=1.

After this, the flow proceeds to step SR09, where i=16 is reached. Then, the flow proceeds to step SR04, and since m=16 and i=16, the flow further proceeds to step SR05, where j=2 is attained. Then the flow proceeds to SR02. After this, steps SR02 to SR09 are similarly repeated for j=2 to 15. After step SR09 and when j=16 is attained, the value of pixel counter “j” for the vertical direction is compared with the maximum number “n” of pixels in the vertical direction. If the result of comparison indicates j≧n, the process of step SR10 is executed. Otherwise, step SR03 is executed next. Here, j=16 and n=16, so that the flow proceeds to step SR10. At this time, in calculation memory 1022, image “WRi” as shown in FIG. 15B is stored, which is generated by superposing the image obtained by displacing the partial image “Ri”, on which the comparison is currently made, to the right oblique direction by one pixel.

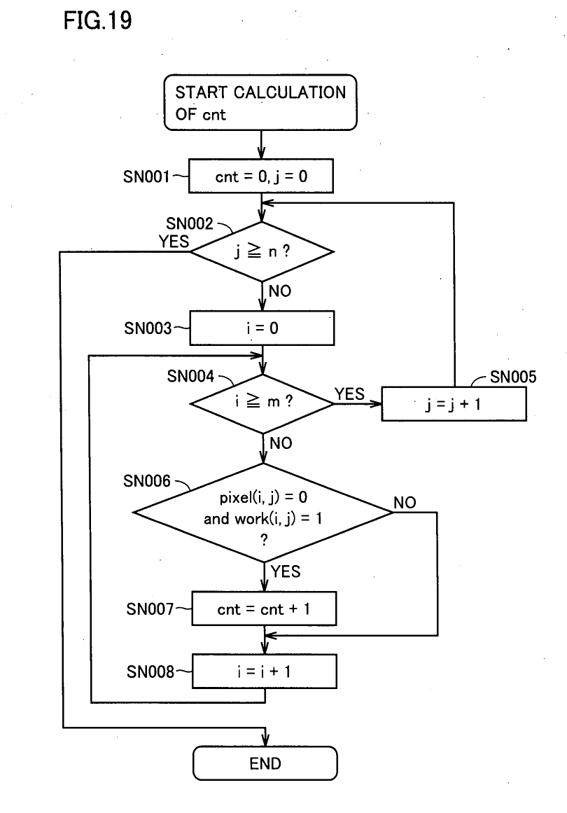

At step SR10, difference “cnt” is calculated between pixel value work (i, j) of image “WRi” generated by superposing the image displaced in the right oblique direction by one pixel and stored in calculation memory 1022 and pixel value pixel (i, j) of partial image “Ri”, which is currently compared and collated. The process for calculating difference “cnt” between “work” and “pixel” is now described with reference to FIG. 19.

FIG. 19 is a flowchart for calculating difference “cnt” between pixel value pixel (i, j) of partial image “Ri” that is currently compared and collated, and pixel value work (i, j) of image “WRi” generated by superimposing images displaced by one pixel in the right oblique direction or the left oblique direction. Image feature value calculating unit 1045 reads from calculation memory 1022 the partial image “Ri” and image “WRi” obtained by displacing one pixel, and initializes difference counter “cnt” and the value of counter “j” for pixels in the vertical direction, namely cnt=0 and j=0 (step SN001). Subsequently, the value of counter “j” for pixels in the vertical direction and the maximum number “n” of pixels in the vertical direction are compared with each other (step SN002). If the result of comparison is j≧n, the flow returns to the flowchart in FIG. 17 where “cnt” is input as “rcnt” at step SR11. Otherwise, step SN003 is subsequently performed.

Here, n=16 and at the start of the process, j=0. Then, the flow proceeds to step SN003. At step SN003, the value of counter for pixels in the horizontal direction, “i”, is initialized, namely i=0. Then, the value of counter “i” for the horizontal direction and the maximum number “im” of pixels in the horizontal direction are compared with each other (step SN004). If the result of comparison indicates i≧m, step SN005 is subsequently performed. Otherwise, step SN006 is subsequently performed. Here, m=16 and, at the start of the process, i=0, so that the flow proceeds to step SN006.

At step SN006, it is determined whether or not pixel value pixel (i, j) of partial image “Ri” at coordinates (i, j) on which the comparison is currently made is 0 (white pixel) and pixel value work (i, j) of image “WRi” generated by superposing the image displaced by one pixel is 1 (black pixel). When the determination provides the results, pixel (i, j)=0 and work (i, j)=1, step SN007 is subsequently performed. Otherwise, step SN008 is subsequently performed. Here, with reference to FIGS. 15A and 15B, the pixel values are pixel (0, 0)=0 and work (0, 0)=0, and the flow proceeds to step SN008.

At step SN008, i=i+1, namely the value of counter “i” for the horizontal direction is incremented by one. Here, the initialization provides i=0 and thus the addition of 1 provides i=1. Then, the flow returns to step SN004. After this, steps SN004 to SN008 are repeated until i=15 is reached. After step SN008 and when i=16 is attained, the flow proceeds to SN004. As m=16 and i=16, the flow proceeds to step SN005.

At step SN005, j=j+1, namely the value of counter “j” for pixels in the vertical direction is incremented by one. At this time, j=0, the addition of 1 provides j=1 and thus the flow returns to SN002. Since the new row is now processed, the flow proceeds to SN003 and SN004. After this, steps SN004 to SN008 are repeated until the pixel in the first row and the 11th column, namely i=10 and j=1 are reached where the pixel values are pixel (i, j)=0 and work (i, j)=1. After step SN008, i=10 is attained. Here, since m=16 and i=10, the flow proceeds to step SN006.

At step SN006, since the pixel values are pixel (i, j)=0 and work (i, j)=1, namely pixel (10, 1)=0 and work (10, 1)=1, the flow proceeds to step SN007.

At step SN007, cnt=cnt+1, namely the value of difference counter “cnt” is incremented by one. Here, since the initialization provides cnt=0, the addition of 1 provides cnt=1. The flow continues to step SN008, where i=16 is reached, and the flow proceeds to step SN004. As m=16 and i=16, the flow proceeds to step SN005 where j=2 is attained, and then the flow proceeds to step SN002.

After this, steps SN002 to SN008 are repeated for j=2 to 15. After step SN008 and when j=16 is attained, the flow proceeds to step SN002 at which the value of counter “j” for the pixels in the vertical direction is compared with the maximum number “n” of pixels in the vertical direction. If the result of comparison indicates j≧n, the flow returns to the flowchart of FIG. 13 and step SR11 is executed. Otherwise, step SN003 is executed. Then, as j=16 and n=16 at this time point, the flowchart of FIG. 19 is terminated, and the process returns to the flowchart of FIG. 17 and proceeds to step SR11. At this time, the difference counter has the value cnt=45.

At step SR11, rcnt=cnt, namely difference “cnt” calculated through the flowchart in FIG. 19 is input as the amount of increase “rcnt” in the case where the image is displaced in the right oblique direction, and the flow subsequently proceeds to step SR12. At step SR12, the amount of increase where the image is displaced in the right oblique direction, that is, “rcnt”=45 is output.

The process through steps SL0 to SL12 of FIG. 18 in the step (step SM2) of determining increase “lcnt” in the case where the image is displaced in the left oblique direction in the step (step T2a) of calculating the partial image feature value shown in FIG. 19 is basically the same as the above-described process in FIG. 17, and the detailed description thereof is not repeated here.

As increase “lcnt” when the image is displaced in the left oblique direction, the difference lcnt=115 between image “WLi” in FIG. 15C obtained by superposing an image displaced in the left oblique direction and partial image “Ri” in FIG. 15A is output.

The process performed on the outputs “rcnt” and “lcnt” is described now, referring back to step SM3 and the following steps in FIG. 16.

At step SM3, comparisons are made between “rcnt” and “lcnt” and the lower limit “lcnt0” of the increase in maximum number of black pixels regarding the left oblique direction. When the conditions lcnt>2×rcnt and lcnt>lcnt0 are satisfied, step SM7 is subsequently performed. Otherwise, step SM4 is subsequently performed. At this time, lcnt=115 and rcnt=45, and assuming that lcnt0=4, the flow subsequently proceeds to step SM7. At step SM7, “R” is output to the feature value storage area for partial image “Ri” for the reference image feature value memory 1024 or sample image feature value memory 1025, and the partial image feature value calculation end signal is transmitted to control unit 108.

If the output values at step SM2 are lcnt=30 and rcnt=20 and lcnt0 is assumed to be lcnt0=4, the flow proceeds to step SM4. If the conditions rcnt>2×lcnt and rcnt≧rcnt0 are satisfied, step SM5 is executed, and otherwise, step SM6 is executed.

Here, the flow proceeds to step SM6, at which “X” is output to the feature value storage area for partial image “Ri” for the reference image feature value memory 1024 or sample image feature value memory 1025. Then, the partial image feature value calculation end signal is transmitted to control unit 108.

Further, if the output values at step SM2 are lcnt=30 and rcnt=70 and it is assumed that lcnt0=4 and rcnt0=4, the conditions lcnt>2×rcnt and lcnt≧lcnt0 are not satisfied at step SM3, and therefore, the flow proceeds to step SM4. If the conditions rcnt>2×lcnt and rcnt≧rcnt0 are satisfied at step SM4, step SM5 is executed next, and otherwise, step SM6 is executed next.

Here, the flow proceeds to step SM5, at which “L” is output to the feature value storage area for partial image “Ri” for the reference image feature value memory 1024 or sample image feature value memory 1025. Then, the partial image feature value calculation end signal is transmitted to control unit 108.

Regarding the feature value calculation described above, even if the reference image “A” or the sample image “B” has noise, for example, even if the fingerprint image is partially missing because of a furrow of the finger and consequently partial image “Ri” has a vertical crease at the center as shown in FIG. 15D, the differences are detected as rcnt=57 and lcnt=124 as shown in FIGS. 15E and 15F. Then, if it is assumed that lcnt0=4, the conditions lcnt>2×rcnt and lcnt≧lcnt0 at step SM3 of FIG. 16A are satisfied. Therefore, step SM7 is executed next, and “R” is stored as the feature value. Thus, the calculation of feature value can maintain calculation accuracy against noise components included in the image.

As discussed above, partial image feature value calculating unit 1045 generates image “WRi” by superposing an image displaced by a prescribed number of pixels in the right oblique direction and image “WLi” by superposing an image displaced by a prescribed number of pixels in the left oblique direction with respect to partial image “Ri”, detects increase “rcnt” in number of pixels that is the difference between image “WRi” generated by superposing the image displaced by one pixel in the right oblique direction and partial image “Ri” and detects increase “lcnt” in number of black pixels that is the difference between image “WLi” generated by superposing the image displaced by one pixel in the left oblique direction and partial image “Ri”, based on these increases, determines whether the pattern of partial image “Ri” is the pattern with the tendency to be arranged in the right oblique direction (for example, right oblique stripe) or the pattern with the tendency to be arranged in the left oblique direction (for example the left oblique stripe) or any except for these patterns, and outputs the value (one of “R”, “L” and “X”) according to the determination.

### Five Types of Feature Values

Feature value calculating unit 1045 may output all the feature values described above. In that case, feature value calculating unit 1045 finds respective amounts of increase “hcnt.”, “vcnt”, “rcnt” and “lcnt” of black pixels in accordance with the procedures described above, and based on these amounts of increase, determines whether the pattern of the partial image “Ri” tends to be arranged in the horizontal (lateral) direction (for example, horizontal stripe), in the vertical (longitudinal) direction (for example, vertical stripe), in the right oblique direction (for example, right oblique stripe) or in the left oblique direction (for example the left oblique stripe) or other than these, and outputs a value corresponding to the result of determination (“H”, “V”, “R”, “L” and “X”). The output value represents the feature value of partial image “Ri”.

Here, values “H” and “V” are used in addition to “R”, “L” and “X” as the feature value of the partial image “Ri”. Therefore, the classification of feature values of the partial image of the object of comparison can be made finer. Even a partial image that would have been classified to “X” according to the classification using three types of feature values could be classified to a value other than “X” if five types of feature values are used for classification. Accordingly, a partial image “Ri” that should be classified to “X” can more exactly be detected.

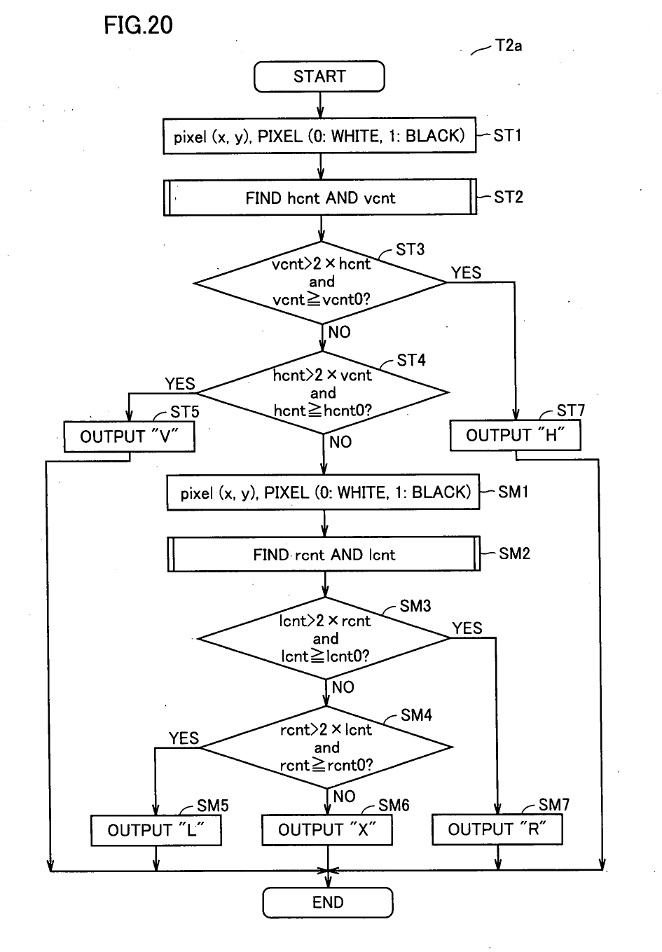

FIG. 20 shows a flowchart related to calculation of five types of feature values. In the calculation of partial image feature values shown in FIG. 20, steps ST1 to ST4 in the partial image feature value calculation step (T2ac) shown in FIG. 11 are similarly performed to make the determination with the results “V” and “H” (ST5, ST7). In this case, if the result of the determination is neither “V” nor “H” (N in ST4), steps SM1 to SM7 for the image feature value calculation (T2a) shown in FIG. 16 are similarly performed. Then, the results of the determination “L”, “X” and “R” are output. Accordingly, through the calculation of partial image feature value (T2a), one of the five different feature values “V”, “H”, “L”, “R” and “X” can be output as the feature value of the partial image.

Here, in view of the fact that there is a notable tendency, for most of fingerprints to be identified, to have the vertical or horizontal pattern, the process shown in FIG. 11 is executed first. However, the order of execution is not limited to the above-described one. The process in FIG. 16 may be performed first and, in the case where it is determined that the feature value is neither “L” nor “R”, then the process in FIG. 11 may be performed.

### Limitation of Search Object

The object of search by maximum matching score position searching unit 105 may be limited in accordance with the feature values calculated in the above-described manner.

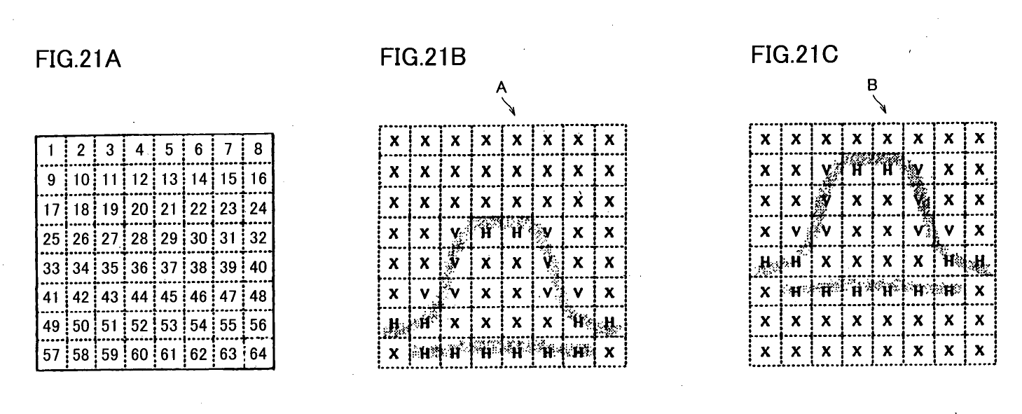

FIGS. 21B and 21C show images “A” and “B”, that have been subjected to the steps of image input (T1) and image correction (T2) and of which partial image feature values are calculated thereafter.

First, referring to FIG. 21A, how to specify the positions of partial images in an image will be described. The shape (form, size) of the image in FIG. 21A is the same as that of images “A” and “B” in FIGS. 21B and 21C. The image in FIG. 21A is equally divided like a mesh into 64 partial images “Ri” each having the same (rectangular) shape. Here, numerical values 1 to 64 are allocated from the upper right to the lower left direction to 64 partial images “Ri” of the image shown in FIG. 21A, and the position of each partial image “Ri” in image “A” or “B” is indicated by the allocated numerical value. Here, each of 64 partial images in the image is identified using the numerical values indicating the corresponding positions, such as partial images “g1”, “g2”, . . . “g64”. As the images of FIGS. 21A, 21B and 21C are identical in shape, the images “A” and “B” of FIGS. 21B and 21C may also be divided into 64 partial images and the positions can be identified similarly as partial images “g1”, “g2”, . . . “g64”. Maximum matching score position searching unit 105 searches for a partial image “Ri” that corresponds to the maximum matching score position in images “A” and “B”, and the order of search is from partial image g1, partial image g2, . . . to partial image g64. It is assumed that each partial image of images in FIGS. 21B and 21C has any of the feature values “H”, “V” and “X” calculated by feature value calculating unit 1045.

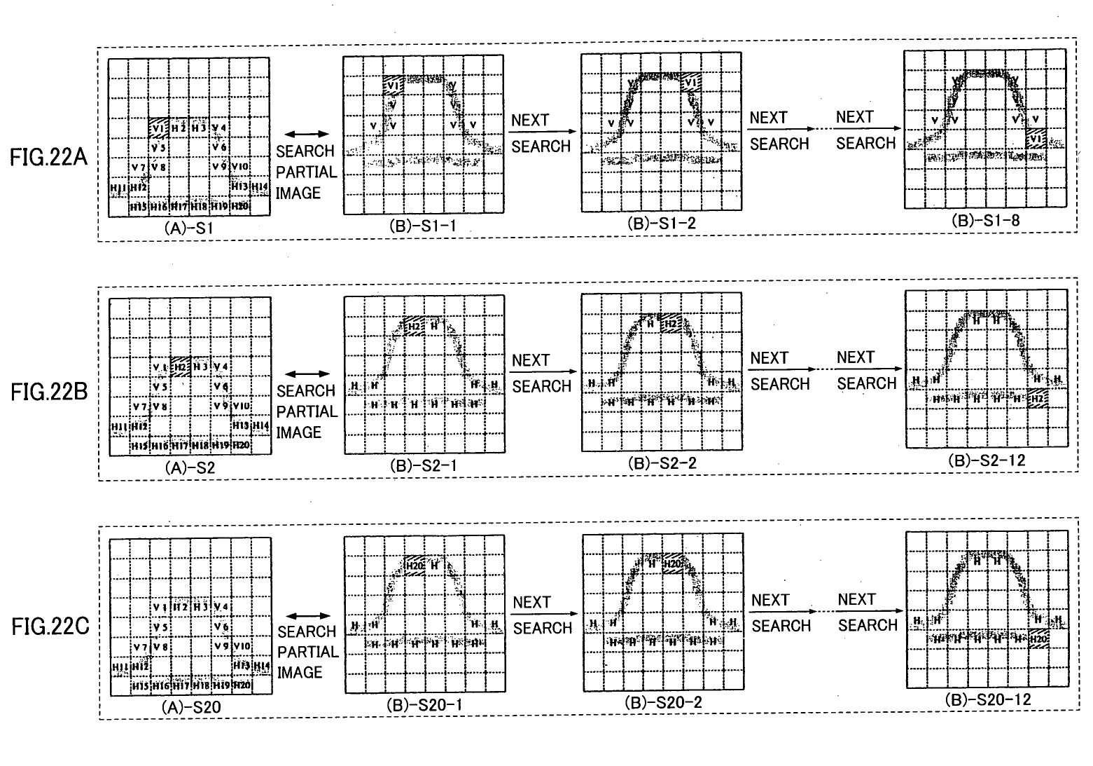

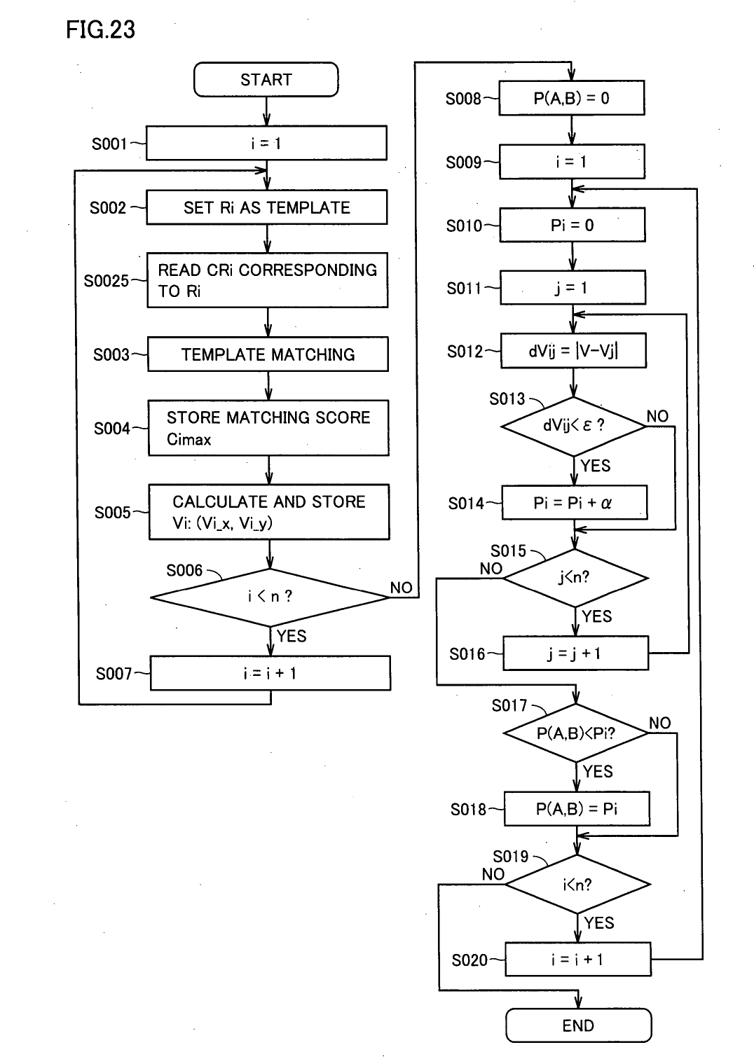

FIGS. 22A to 22C represent the procedure for searching for the maximum matching score position of images “A” and “B”, of which feature values of partial images have been calculated as shown in FIGS. 21B and 21C. FIG. 23 is a flowchart representing the process of maximum matching score position searching and calculating similarity score.

Maximum matching score position searching unit 105 searches image “A” of FIG. 21A, and for a partial image having the feature value “H” or “V”, searches for a partial image that has the same feature value in image “B”. Therefore, among the partial images of image “A”, the first partial image having the partial image feature value “H” or “V” is the first partial image for which the search is conducted. The image (A)-S1 shown in FIG. 22A is a partial image of image “A” having a partial image feature value, that is, an image having partial image “g27” first identified as a partial image with feature value “H” or “V”, namely “V1”, indicated by hatching.

As can be seen from this image (A)-S1, the first detected partial image feature value is “V”. Therefore, among partial images of image “B”, the partial images having the partial image feature value “V” are to be searched for. The image (B)-S1-1 of FIG. 22A shows image “B” in which partial image “g11” that is first identified as a partial image having feature value “V”, that is, “V1” is hatched. On this identified partial image, the process of steps S002 to S007 of FIG. 23 is performed.

Thereafter, the process is performed on partial image “g14” having feature value “V” subsequently to partial image “g11”, that is, “V1” (image (B)-S1-2 of FIG. 22A), and thereafter performed on partial images “g19”, “g22”, “g26”, “g27”, “g30” and “g31” (image (B)-S1-8 of FIG. 21A). Thus, the process is completed for partial image “g27” that is first identified as a partial image having feature value “H” or “V in image “A”. Then the process of steps S002 to S007 of FIG. 23 is performed similarly for partial image “g28” that is next identified as a partial image having feature value “H” or “V” (image (A)-S2 of FIG. 22B). As the partial image feature value of partial image “g28” is “H”, the process of searching is performed on partial image “g12” (image (B)-S2-1 of FIG. 22B), image “g13” (image (B)-S2-2 of FIG. 22B) and “g33”, “g34”, “g39”, “g40”, “g42” to “g46” and “g47” (image (B)-S2-12 of FIG. 22B) that have feature value of “H” in image “B”.

Thereafter, for partial images “g29”, “g30”, “g35”, “g38”, “g42”, “g43”, “g46”, “g47”, “g49”, “g50”, “g55”, “g56”, “g58” to “g62” and “g63” (image (A)-S20 of FIG. 22C) that have feature value “H” or “V” in image “A”, the process for searching is performed similarly in image “B”.

The number of partial images for which the search is conducted in images “A” and “B” by maximum matching score position searching unit 105 is given by the expression: (the number of partial images in image “A” that have partial image feature value “V”×the number of partial images in image “B” that have partial image feature value “V”+the number of partial images in image “A” that have partial image feature value “H”×the number of partial images in image “B” that have partial image feature value “H”). The number of partial images searched by the procedure in the example shown in FIGS. 22A to 22C is 8×8+12×12=208.

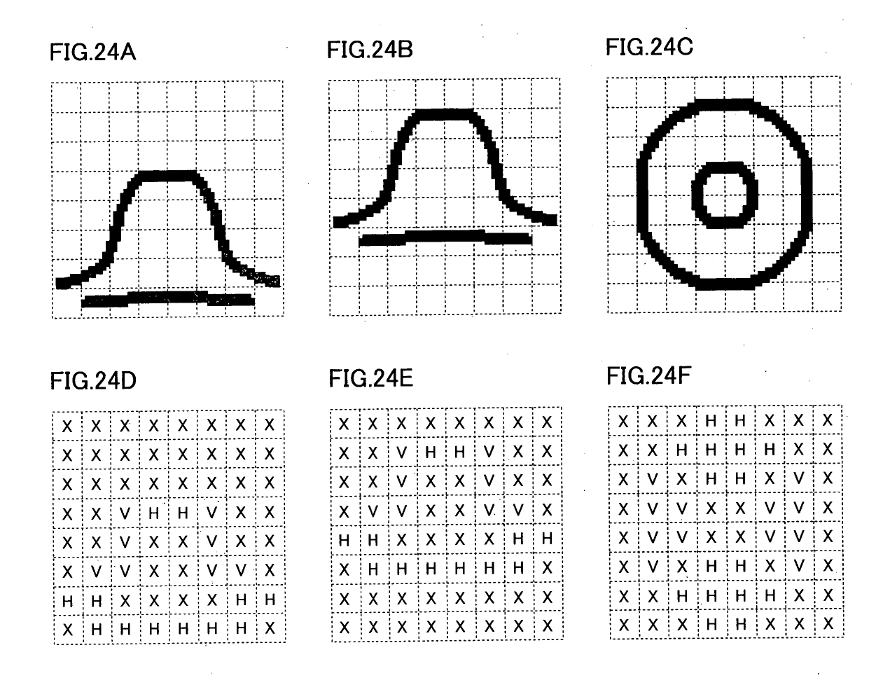

Since the partial image feature value in accordance with the present embodiment depends also on the pattern of the image, an example having a pattern different from that of FIGS. 21A and 21B will be described. FIGS. 24A and 24B show images “A” and “B” different from images “A” and “B” of FIGS. 21B and 21C, and FIG. 24C shows an image “C” different in pattern from image “B” of FIG. 21C.

FIGS. 24D, 24E and 24F show respective feature values of partial images calculated by feature value calculating unit 1045, of images “A”, “B” and “C” shown respectively in FIGS. 24A, 24B and 24C.

For image “A” shown in FIG. 24A, the number of partial images to be searched for by maximum matching score position searching unit 105 in image “C” shown in FIG. 24C is similarly given by the expression: (the number of partial images in image “A” having partial image feature value “V”×the number of partial images in image “C” having partial image feature value “V”+the number of partial images in image “A” having partial image feature value “H”×the number of partial images in image “C” having partial image feature value “H”). Referring to FIGS. 24D and 24F, the number of partial images to be searched for is 8×12+12×16=288.

Although the partial images having the same feature value are searched for according to the description above, the present invention is not necessarily applied to this. When the reference image feature value is “H”, the partial areas that have sample image feature values “H” and “X” may be searched for and, when the reference image feature value is “V”, the areas that have sample image feature values “V” and “X” may be searched for, so as to improve accuracy in the comparing process.

Feature value “X” means that the correlated partial image has a pattern that cannot be specified as vertical stripe or horizontal stripe. In order to increase the speed of the comparing process, partial areas having feature value “X” may be excluded from the scope of search by maximum matching score position searching unit 105.

In order to improve accuracy, not only the values “H” and “V” but also values “L” and “R” may be applied.

### Determination of Image Element Not Eligible for Comparison

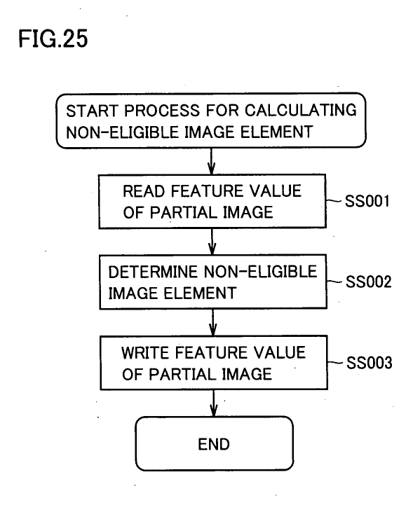

The image that has been corrected by image correcting unit 104 and of which feature values of partial images have been calculated by feature value calculating unit 1045 is next subjected to a calculation process for determining image element that is not eligible for comparison (step T2b). The process is as shown in the flowchart of FIG. 25.

Here, it is assumed that each partial image in the image as the object of comparison comes to have feature value of “H”, “V”, “L” or “R” (four values), by a process by element determining unit 1047. Specifically, if there is a stained area on fingerprint reading surface 201 of fingerprint sensor 101 or there is an area from which an image cannot be input as the fingerprint is absent (finger is not placed) thereon, a partial image corresponding to such an area basically has the feature value “X”. Using such a characteristic, element determining unit 1047 detects (determines), in the input image, the stained partial area or the partial area at which fingerprint image is not available, as an image element not eligible for comparison. Then, a process is done to allocate a feature value “E” to such a detected area. Here, allocation of feature value “E” to a partial area of the image (partial image) means that the corresponding partial area (partial image) is excluded from the scope of search by maximum matching score position searching unit 105 performed for image comparison by comparison/determination unit 107 and that it is excluded from the object of similarity score calculation by similarity score calculating unit 106.

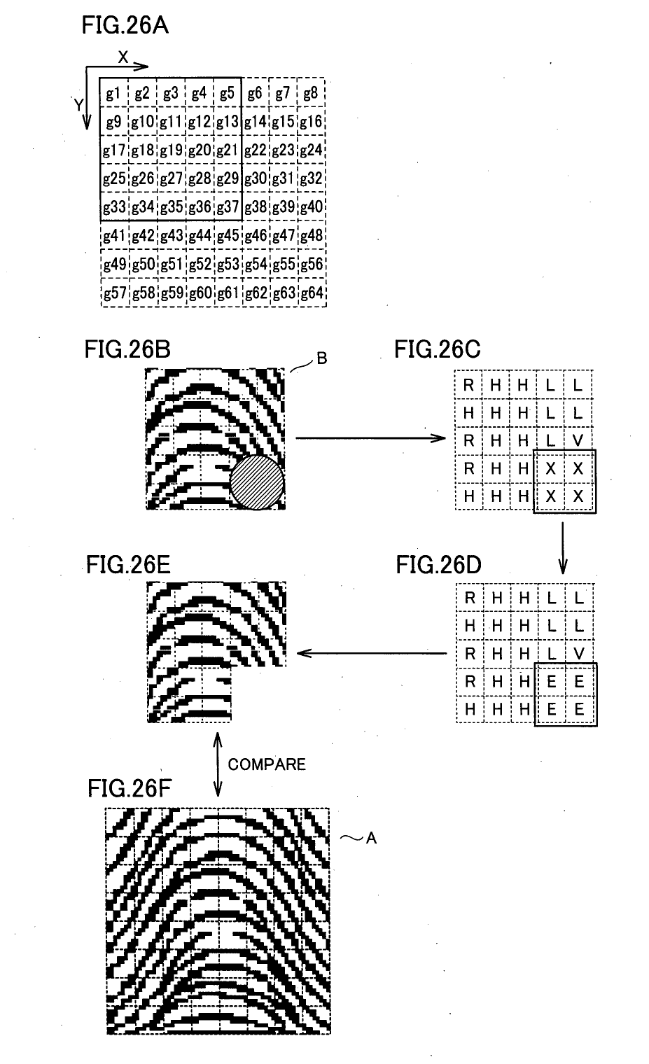

FIGS. 26A to 26F schematically show determination of elements not eligible for comparison, and the manner of comparison. FIGS. 26B and 26F schematically represent sample image “B” and reference image “A”. As can be seen from FIG. 26A, reference image “A” has 64 partial images prepared by equally dividing the image by 8 along the vertical and horizontal directions, respectively. In FIG. 26A, respective partial images are indicated by numerical values “g1” to “g64” representing image positions.

Sample image “B” of FIG. 26 is equally divided by 5 along the vertical and horizontal directions, so that 25 partial images of the same size and shape result. To these 25 partial images, positions g1 to g5, g9 to g13, g17 to g21, g25 to g29 and g33 to g37 of FIG. 26A are allocated for indication. It is noted that image “B” has a stained portion (represented by a hatched circle in the figure). For simplicity of description here, it is assumed that in reference image “A”, feature values calculated for each partial image are other than “X” and “E” (“H”, “V”, “L” and “R”).

Element determining unit 1047 reads the feature value of each of the partial images corresponding to sample image “B” of FIG. 26B calculated by feature value calculating unit 1045, from sample image feature value memory 1025 to calculation memory 1022. The read state is schematically shown in FIG. 26C (step SS001 of FIG. 25).

Next, element determining unit 1047 searches the feature values of respective partial images of FIG. 26C of calculation memory 1022 in the ascending order of numerical values representing the positions of partial images, for an image element that is not eligible for comparison (step SS002 of FIG. 25). Here, if a partial image having the feature value of “X” is found during searching, feature values of partial images neighboring the partial image of interest are searched. If a partial image having the feature value “X” is detected adjacent to the partial image of interest in at least one direction, that is, longitudinal direction (along the Y-axis), lateral direction (along the X-axis), or oblique direction (along an axis inclined by 45° from the X or Y axis) as a result of search, a set of the partial image of interest and the detected adjacent partial image is detected (determined) as the image element not eligible for comparison.

Specifically, feature values of partial images of sample image “B” shown in FIG. 26C stored in calculation memory 1022 are successively searched, in the order from partial image g1, g2, g3, g4, g5, g9, . . . g13, g17 . . . . In the process of search, if a partial image having the feature value “X” or “E” is detected, feature values of all partial areas neighboring the partial image of interest, that is, partial images on the upper, lower, left, right, upper right, lower light, upper left and lower left sides, are searched. If a feature value of “X” is found in any neighboring partial image as a result of search, the value “X” is rewritten to “E” in calculation memory 1022 (step SS003 of FIG. 25). When the search is complete for all the partial images of sample image “B” in this manner, feature values of respective partial images of sample image “B” are updated from those of FIG. 26C to FIG. 26D. Updated values of respective partial images are stored in sample image feature value memory 1025.

An example of this rewriting will be described. Referring to FIG. 26C, feature values are searched successively, starting from partial image “g1”. The partial image having the feature value “X” is first detected when the partial image “g28” is searched. The feature values of all partial images neighboring “g28” are searched, and it is found that neighboring partial images “g29”, “g36” and “g37” have feature values “X”. Based on the result of detection, feature values “X” of partial images “g28”, “g29”, “g36” and “g37” are updated (rewritten) to “E” as shown in FIG. 26D.

Here, a partial area consisting of at least two partial images having the feature value “X” continuous in at least one of longitudinal, lateral and oblique directions of sample image “B” is determined as an image element not eligible for comparison. The reference for determination is not limited to this. By way of example, the partial image having the feature value “X” itself may be determined to be the element not eligible for comparison, or other combination may be used.

### Similarity Score Calculation and Comparison/Determination

Next, the search for the maximum matching score position and the process of similarity score calculation based on the result of search (step T3 of FIG. 5), considering the result of determination of image element not eligible for comparison by element determining unit 1047 will be described with reference to the flowchart of FIG. 23. Here, the total number of partial images (partial areas) in image “A” is represented by a variable “n”. The search for the maximum matching score position and similarity score calculation are performed using each partial image of reference image “A” of FIG. 26A and image “B” having elements determined to be non-eligible for comparison excluded, shown in FIG. 26E, as the object.

At the end of determination by element determining unit 1047, control unit 108 transmits a template matching start signal to maximum matching score position searching unit 105, and waits until a template matching end signal is received.

Receiving the template matching start signal, maximum matching score position searching unit 105 starts the template matching process represented by steps S001 to S007. At step S001, the value of a counter variable “i” is initialized to 1. At step S002, an image of a partial area defined as partial image “Ri” of reference image “A” is set as a template to be used for template matching.

At step S0025, maximum matching score position searching unit 105 searches in reference image feature value memory 1024 and reads a feature value “CRi” of partial image “Ri” as the template.

At step S003, a position having the highest matching score with the template set at step S002 in image “B”, that is, a position of which data matches the most in image “B”, is searched. In this search, the following calculation is performed only on the partial image of image “B” that has a feature value other than “E”.

Let us represent the pixel density at coordinates (x, y) with an upper left corner of rectangular partial image “Ri” used as the template being the reference by “Ri” (x, y), pixel density at coordinates (s, t) with an upper left corner of image “B” being the reference by B(s, t), the width of partial image “Ri” by “w”, height by “h”, and maximum possible density of each pixel in images “A” and “B” by “V0”. Here, matching score Ci(s, t) at coordinates (s, t) of image “B” is calculated, for instance, based on the difference in density of each pixel, in accordance with the following equation (Equation 1).

$$Ci ( s , t ) = {\sum }_{y = 1}^{h} {\sum }_{x = 1}^{w} ( V 0 - \vert Ri ( x , y ) - B ( s + x , t + y ) \vert ) \qquad ( Equation 1 )$$

The coordinates (s, t) are successively updated in image “B”, and after every update, matching score Ci(s, t) at the updated coordinates is calculated. The position in image “B” that corresponds to the largest value among the calculated matching scores C(s, t) is determined to be the best match with partial image “Ri”, and the image of the partial area of that position in image “B” is regarded as partial area “Mi”. The matching score C(s, t) corresponding to that position is set as the maximum matching score “Cimax”.

At step S004, the maximum matching score “Cimax” is stored at a prescribed address of memory 102. At step S005, movement vector “Vi” is calculated in accordance with Equation (2) below, and the calculated movement vector is stored in a prescribed address of memory 102.

Here, as described above, based on a partial image “Ri” corresponding to a position “P” in image “A”, image “B” is scanned (searched) and, if a partial area “Mi” of a position having the highest matching score with partial image “Ri” is detected as a result, a directional vector from position “P” to position “M” is referred to as movement vector “Vi”. The manner how a finger is placed on fingerprint reading surface 201 of fingerprint sensor 101 is not uniform, and movement vector “Vi” represents that when one of the images, for example, image “A” is used as a reference, the other image “B” seems to have moved. Movement vector “Vi” represents direction and distance and, therefore, the movement vector represents positional relation between partial image “Ri” of image “A” and partial image “Mi” of image “B” in a quantified manner.
Vi=(Vix, Viy)=(Mix−Rix, Miy−Riy) (Equation 2)

In Equation 2, variables “Rix” and “Riy” represent values of x and y coordinates of the reference position of partial image “Ri”, which correspond, for example, to the coordinates at the upper left corner of partial image “Ri” in image “A”. Further, variables “Mix” and “Miy” represent values of x and y coordinates of the position corresponding to the maximum matching score “Cimax” calculated by the search in partial area “Mi”. By way of example, these values correspond to the coordinates at the upper left corner of partial area “Mi” at the matching position in image “B”.

At step S006, the value of counter variable “i” is compared with the value of variable “n”, and based on the result of comparison, whether the value of counter variable “i” is smaller than the value of “n” or not is determined. If it is determined that the value of variable “i” is smaller than the value of variable “n”, the process proceeds to step S007, and otherwise, the process proceeds to step S008.

At step S007, 1 is added to the value of variable “i”. Thereafter, as long as the value of variable “i” is determined to represent a value smaller than the variable “n”, steps S002 to S007 are repeated. Specifically, for every partial area “Ri” of image “A”, template matching is performed only on that partial area of image “B” which has the feature value “CM” same as the corresponding feature value “CRi” read by searching reference image feature value memory 1024 for the partial area “Ri”, and the maximum matching score “Cimax” of each partial image “Ri” and movement vector “Vi” are calculated.

After the successively calculated maximum matching score “Cimax” and movement vector “Vi” of all the partial images “Ri” are stored at prescribed addresses of memory 102, maximum matching score searching unit 105 transmits a template matching end signal to control unit 108 and ends the process.

Thereafter, control unit 108 transmits a similarity score calculation start signal to similarity score calculating unit 106, and waits until a similarity score calculation end signal is received. Similarity score calculating unit 106 performs processes shown from step S008 to S020 of FIG. 23 to calculate the similarity score, using information such as the movement vector “Vi” and maximum matching score “Cimax” of each partial image “Ri” obtained by the template matching and stored in memory 102.

At step S008, the value of similarity score P(A, B) is initialized to 0. Here, similarity score P(A, B) refers to a variable storing the degree of similarity between images “A” and “B”. At step S009, the value of an index “i” of movement vector “Vi” used as a reference is initialized to 1. At step S010, the value of similarity score “Pi” related to the movement vector “Vi” as a reference is initialized to 0. At step S011, an index “j” of a movement vector “Vj” is initialized to 1. At step S012, vector difference “dVij” between reference movement vector “Vi” and movement vector “Vj” is calculated in accordance with Equation 3 below.
dVij=|Vi−Vj|=sqrt((Vix−Vjx)ˆ2+(Viy−Vjy)ˆ2) (Equation 3)
where variables “Vix” and “Viy” represent x-directional and y-directional components of movement vector “Vi”, variables “Vjx” and “Vjy” represent x-directional and y-directional components of movement vector “Vj”, variable sqrt(X) represents a root of X, and Xˆ2 represents an operation for calculating a square of X.

At step S013, the vector difference “dVij” between movement vectors “Vi” and “Vj” is compared with a threshold value represented by a constant ε, and based on the result of comparison, whether it is possible to regard the movement vectors “Vi” and “Vj” as substantially the same movement vector or not is determined. If the result of determination shows that the value of vector difference “dVij” is smaller than the threshold value (vector difference) indicated by constant ε, it is determined that movement vectors “Vi” and “Vj” are substantially the same, and the process proceeds to step S014. If the result shows that the difference is not smaller than constant ε, the two vectors are not determined to be substantially the same, and the process proceeds to step S015. At step S014, the value of similarity score “Pi” is increased in accordance with Equations 4 to 6 below.
Pi=Pi+α (Equation 4)
α=1 (Equation 5)
α=Cjmax (Equation 6)

The variable α in Equation 4 is a value of increasing similarity score “Pi”. When this is set as α=1 according to Equation 5, similarity score “Pi” comes to represent the number of partial areas that have the same movement vector as movement vector “Vi” used as the reference. If this is set as α=Cjmax according to Equation 6, similarity score “Pi” comes to represent the total sum of maximum matching scores at the time of template matching for the partial areas having the same movement vector as the movement vector “Vi” used as the reference. It is also possible to make the value of variable α smaller, in accordance with the magnitude of vector difference “dVij.”

At step S015, whether the value of index “j” is smaller than the value of variable “n” or not is determined. If the value of index “j” is smaller than the total number of partial areas represented by variable “n” as a result of determination, the process proceeds to step S016, and if it is not smaller than the total number, the process proceeds to step S017. At step S016, the value of index “j” is incremented by 1. By the process of steps S010 to S016, similarity score “P” is calculated using the information of partial area determined to have the same movement vector as the movement vector “Vi” used as a reference. At step S017, similarity score “Pi” with movement vector “Vi” used as the reference is compared with the value of variable P(A, B), and if the value of similarity score “Pi” is lager than the largest similarity score (value of variable P(A, B)) to that time point, the process proceeds to step S018, and if it is not larger, the process proceeds to S019.

At step S018, the value of similarity score “Pi” when movement vector “Vi” is used as the reference is set as variable P(A, B). At steps S017 and S018, if the similarity score “Pi” with movement vector “Vi” used as the reference is larger than the maximum value (value of variable P(A, B)) of the similarity score with other movement vector used as a reference calculated up to that time point, the movement vector “Vi” used as the reference is considered the most relevant as the reference, among the indexes “i” used up to that time point.

At step S019, the value of index “i” of movement vector “Vi” used as the reference is compared with the number of partial areas (value of variable “n”). If the value of index “i” is smaller than the number of partial areas, the process proceeds to step S020. At step S020, the index “i” is incremented by 1.

From step S008 to step S020, the similarity score between images “A” and “B” is calculated as the value of variable P(A, B). Similarity score calculating unit 106 stores the value of variable P(A, B) calculated in the above-described manner at a prescribed address of memory 102, transmits the similarity score calculation end signal to control unit 108 and ends processing.

Thereafter, control unit 108 transmits a comparison/determination start signal to comparison/determination unit 107, and waits until a comparison/determination end signal is received. Specifically, the similarity score represented by the value of variable P(A, B) stored in memory 102 is compared with a predetermined comparison threshold value T. If variable P(A, B)≧T as a result of comparison, it is determined that the image “A” and image “B” are taken from the same fingerprint, and as a result of comparison, a value representing a “match”, for example, “1”, is written to a prescribed address of memory 102. Otherwise, it is determined that the images come from different fingerprints, and a value representing a “mismatch”, for example, “0”, is written to a prescribed address of calculation memory 1022. Then, a comparison/determination end signal is transmitted to control unit 108; and the process ends.

Receiving the comparison/determination end signal, control unit 108 reads the result of comparison from calculation memory 1022, and determines if the read result of comparison indicates a “match” or not (step T3a). If the result of determination indicates a “mismatch”, the process proceeds to step T4, and a message of “comparison mismatch” is output. If the result of determination represents a “match,” control unit 108 transmits an instruction signal to ratio calculating unit 1048 to start ratio calculation, and waits until a ratio calculation end signal is received.

Receiving the ratio calculation start instruction signal, ratio calculating unit 1048 calculates the ratio occupied by non-eligible elements in image “B” (step T3b). Ratio calculating unit 1048 searches in sample image feature value memory 1025, counts the total number of partial images of sample image “B”, sets the count value as a variable “N”, counts the number of partial images indicating the feature value other than “X” or “E”, and sets the count value as a variable “NNE”. Then, the ratio “PE” of image elements that are not eligible for comparison with respect to sample image “B” is calculated in accordance with the equation PE=1−(NNE/N). The calculated value “PE” is stored in calculation memory 1022, and the calculation end signal is transmitted to control unit 108.

The ratio “PE” calculated in this manner can be regarded as indicating the reliability of the result of comparison process. Specifically, even if the comparison result is a match, the reliability of the comparison result is not high if the ratio “PE” is large. Specifically, large number of partial images were not used for comparison, and therefore, the comparing process was done only on partial images of a very limited area. On the contrary, if the value “PE” is small, reliability of comparison result is believed to be high. The number of partial images not used for comparison is small, and comparing process is done on large number of partial images.

Receiving the calculation end signal, control unit 108 transmits an instruction signal to start determination as to whether execution of an application is to be permitted or not, and waits until a permission determination end signal is received.

Receiving the instruction signal to start determination of permission from control unit 108, execution permitting unit 1049 performs a process for determining whether execution of the application is to be permitted or not (step T3c).

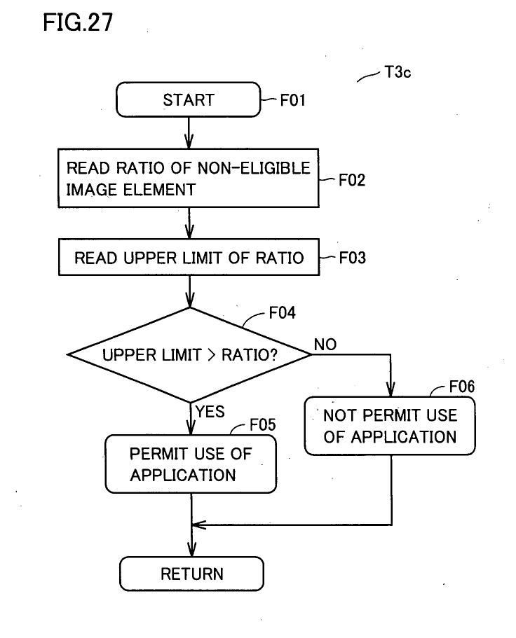

The process for determining whether execution of the application is to be permitted or not of step T3b will be described with reference to the flowchart of FIG. 27. Referring to FIG. 27, execution permitting unit 1049 starts the process upon reception of the instruction signal to start permission determination (step F01).

After the start of the process, first, the ratio represented by variable “PE” is read from calculation memory 1022 (step F02). Then, security rank table 1026 is looked up based on the identification information of the desired application input in advance through input unit 700, and the upper limit value indicated by data 1028 corresponding to application list 1029 with which the identification information of the application is registered is read (step F03).

Execution permitting unit 1049 compares the value indicated by the read variable “PE” with the upper limit value indicated by upper limit data 1028 (step F04). By this comparison, whether the result of comparing process satisfies the degree of reliability (security level) required for activating the desired application or not is detected. Based on the result of comparison, if it is determined that the condition of “upper limit value>value of variable ‘PE’” is satisfied (YES at step F04), it is determined that use (execution/activation) of the desired application program is permitted, and the result of determination is stored in calculation memory 1022 (step F05). If it is determined that the condition is not satisfied (NO at step F04), it is determined that use (execution/activation) of the desired application program is not permitted (inhibited), and the result of determination is stored in calculation memory 1022 (step F06). After the result of determination is stored in calculation memory 1022, the permission determination end signal is transmitted.

Receiving the permission determination end signal from execution permitting unit 1049, control unit 108 reads the result of processing by execution permitting unit 1049 from calculation memory 1022, and outputs the read result through display 610 or printer 690 (step T4).

Receiving the permission determination end signal, CPU 622 reads the result of determination indicating whether use of the desired application is permitted or inhibited, stored in calculation memory 1022, and if it is determined that the read determination result indicates “permission”, reads the program of the desired application by searching in memory 624 based on the identification information of the desired application input through input unit 700, and starts execution of the read program. If it is determined that the read determination result indicates “non-permission” (inhibition), execution of the program indicated by the identification information of the desired application is not started. In that case, if any other program is being executed, CPU 622 continues execution of said program, and if no other program is being executed and the operation is in a standby state, CPU 622 operates to maintain the standby state.

It is possible for the user to know whether start of execution of the application of which use (execution) is desired is permitted or inhibited, by confirming the result output at step T4. Therefore, if the start of execution of the desired application has been instructed but the execution of the application does not start, that is, execution of another program continues in the computer of FIG. 2 or standby state continues without executing any program, it is possible to know that the execution of the desired program is hindered not because of any system bug or failure of the computer.

Though the application as the application processing unit is provided as software (program) here, it may be implemented as hardware formed of a circuitry or the like. In that case, activation means application of a voltage (current) signal of a prescribed level for driving to the circuitry. Further, inhibition of activation means, for example, cut off of the supply voltage to the circuit, or not supplying any voltage (current) signal for driving.

In the present embodiment, some or all of image correcting unit 104, partial image feature value calculating unit 1045, image element determining unit 1047, ratio calculating unit 1048, execution permitting unit 1049, position searching unit 105, similarity score calculating unit 106, comparison/determination unit 107 and control unit 108 may be implemented using an ROM such as memory 624 storing the process procedures as a program and an operating unit such as CPU 622 for executing the program.

### Effects of the Embodiment

Specific examples of the process in accordance with the embodiment and effects attained thereby will be described.

Here, it is assumed that data shown in FIG. 4 have been stored beforehand in security rank table 1026. As can be seen from FIG. 4, in list 1029 of applications requiring high level of security indicated by corresponding data 1027, a name of an application program for electronic transactions, for example, “electronic transaction” is registered. Generally, execution of a program for electronic transactions requires high level of security. Therefore, as the upper limit of the ratio of non-eligible element occupying the image as the object of comparison represented by the corresponding upper limit data 1028, for example, 0.05 (5%) is registered. In the list 1029 of applications requiring middle level of security indicated by corresponding data 1027, names of application programs such as electronic mail software and office-use software, such as “e-mail” and “office-use” are registered. The required level of security is lower than that of “electronic transaction” program, and therefore, as the upper limit of the ratio of non-eligible element occupying the image as the object of comparison represented by the corresponding upper limit data 1028, for example, 0.1 (10%) is registered. As for the application list 1029 in which a name “display” of an image quality adjusting program for display 610 requiring lower level of security than “electronic transaction”, “e-mail” and “office-use” is registered, as the upper limit of the ratio of non-eligible element occupying the image as the object of comparison represented by the corresponding upper limit data 1028, for example, 0.2 (20%) is registered.

Assume that the sample image “B” of FIG. 26B is input by image input unit 101. Because of the dirt on fingerprint reading surface 201 of fingerprint sensor 100, the image of the hatched portion is detected as the non-eligible element, by element determining unit 1047. Therefore, in the process for image comparison by maximum matching score position searching unit 105, similarity score calculating unit 106 and comparison/determination unit 107, only the image of the reduced area (excluding the hatched area) shown in FIG. 26E of fingerprint image “B” shown in FIG. 26B is used as the object of comparing process.

For the image of FIG. 26E, the ratio of non-eligible elements represented by variable PE is calculated as PE=1−(21/25), and the value of variable PE is 0.16 (16%).

Here, security rank table 1026 of FIG. 4 is searched, based on the calculated value of variable PE. By the search, upper limit data 1028 indicating an upper limit higher than the value of variable PE (=16%) is identified, and the contents registered with application list 1029 that correspond to the identified upper limit data 1028 are read. Here, the value of variable PE is calculated to be 16%, and hence, as a result of search of security rank table 1026, only “display” is output as the application program. Therefore, though execution of an application program related to display 610 of the computer shown in FIG. 2 is possible, execution of the process for electronic transaction by an operation of the computer, the process related to electronic mail (transmission, reception, viewing and the like) and the process for office-use (document formation, spreadsheet and the like) is inhibited (not permitted). Therefore, if execution of the not-permitted process is desired, it is necessary for the user to wipe out the dirt on fingerprint reading surface 201 of fingerprint sensor 100, and to place the finger on reading surface 201 to be subjected to the comparing process of FIG. 3 again.

As described above, in the present embodiment, in security rank table 1026, for each application program, data 1028 representing the upper limit of the ratio of image elements not eligible for comparison occupying the sample (input) image as the object of comparison is stored in advance in accordance with the required level of security for the program. Therefore, when execution of an application program requiring low level of security is desired, the upper limit indicated by corresponding data 1028 is low, possibility of repeating the comparing process shown in FIG. 3 becomes low, and convenience for the user is not impaired. If execution of an application program requiring high level of security is desired, the upper limit indicated by corresponding data 1028 is high, and possibility of repeating the comparing process shown in FIG. 3 becomes high. If, however, the hatched portion (stained portion) of FIG. 26B is excluded and the result of comparison of fingerprints performed in this state is output, that is, when the accuracy of comparison results is low, permission/inhibition of execution is again determined by repeated comparing process. Therefore, the security level required of the application program can be maintained.

### Embodiment 2

The process functions for image comparison are realized by a program. According to Embodiment 2, the program is stored in a computer readable recording medium.

As for the recording medium, in Embodiment 2, the program medium may be a memory necessary for the processing by the computer, such as memory 624, or, alternatively, it may be a recording medium detachably mounted on an external storage device of the computer and the program recorded thereon may be read through the external storage device. Examples of such an external storage device are a magnetic tape device (not shown), an FD drive 630 and a CD-ROM drive 640, and examples of such a recording medium are a magnetic tape (not shown), an FD 632 and a CD-ROM 642. In any case, the program recorded on each recording medium may be accessed and executed by CPU 622, or the program may be once read from the recording medium and loaded to a prescribed storage area shown in FIG. 2, such as a program storage area of memory 624, and then read and executed by CPU 622. The program for loading is stored in advance in the computer.

Here, the recording medium mentioned above is detachable from the computer body. A medium fixedly carrying the program may be used as the recording medium. Specific examples may include tapes such as magnetic tapes and cassette tapes, discs including magnetic discs such as FD 623 and fixed disk 626 and optical discs such as CD-ROM 642/MO (Magnetic Optical Disc)/MD (Mini Disc)/DVD (Digital Versatile Disc), cards such as an IC card (including memory card)/optical card, and semiconductor memories such as a mask ROM, EPROM (Erasable and Programmable ROM), EEPROM (Electrically EPROM) and a flash ROM. The computer shown in FIG. 2 has a configuration that allows connection to a communication network 300 including the Internet for establishing communication. Therefore, the program may be downloaded from communication network 300 and held on a recording medium in a non-fixed manner. When the program is downloaded from communication network, the program for downloading may be stored in advance in the computer, or it may be installed in advance from a different recording medium.

The contents stored in the recording medium are not limited to a program, and may include data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus performing a process based on a result of comparison of an image for identifying an individual, comprising:
a feature value detecting unit for detecting and outputting, in correspondence with each of partial images of said image as an input, a feature value in accordance with a pattern represented by said partial image;
a non-eligibility detecting unit for detecting a partial image to be excluded from an object of a comparing process in said input image, based on the feature value output by said feature value detecting unit;
a comparing unit for performing said comparing process using said input image with said partial image detected by said non-eligibility detecting unit excluded; and
a ratio calculating unit for calculating ratio of said partial image detected to be excluded from the object by said non-eligibility detecting unit, relative to said input image as a whole; wherein
permission or inhibition of a designated application process is controlled by a result of said comparing process by said comparing unit and by said ratio calculated by said ratio calculating unit.

2. The information processing apparatus according to claim 1, wherein to said designated application process, a security level required for activating the application process is allocated in advance; and
permission or inhibition of said designated application process is controlled by a result of said comparing process by said comparing unit and a result of comparison between said ratio calculated by said ratio calculating unit and said allocated security level.

3. The information processing apparatus according to claim 1, wherein
in said comparing process, said input image with said partial image detected by said non-eligibility detecting unit excluded is compared with a reference image prepared in advance; and
when a result of said comparing process indicates a mismatch between said input image and said reference image, permission or inhibition of said designated application process is controlled by said ratio calculated by said ratio calculating unit.

4. The information processing apparatus according to claim 1, wherein
said non-eligibility detecting unit detects a combination of said partial images having a prescribed feature value output by said feature value detecting unit.

5. The information processing apparatus according to claim 4, wherein
said image represents a fingerprint pattern; and
said feature value output by said feature value detecting unit is classified into a value indicating that said pattern of said partial image runs along a vertical direction of said fingerprint, a value indicating that it runs along a horizontal direction of said fingerprint, and a value indicating otherwise.

6. The information processing apparatus according to claim 5, wherein
said prescribed feature value represents said value indicating otherwise.

7. The information processing apparatus according to claim 6, wherein
said combination consists of a plurality of said partial images having said value indicating otherwise, positioned adjacent to each other in a prescribed direction in said input image.

8. The information processing apparatus according to claim 4, wherein
said image represents a fingerprint pattern; and
said feature value output by said feature value detecting unit is classified into a value indicating that said pattern of said partial image runs along a right oblique direction of said fingerprint, a value indicating that it runs along a left oblique direction of said fingerprint, and a value indicating otherwise.

9. The information processing apparatus according to claim 1, wherein
said comparing unit includes
a position searching unit for searching, in each of a plurality of partial areas of a reference image prepared in advance to be an object of comparison, a position of an area attaining maximum matching score with the partial image, in the partial areas excluding the area of said partial image detected by said non-eligibility detecting unit in said input image,
a similarity score calculating unit for calculating a similarity score between said input image and said reference image, based on information of said partial area of which positional relation amount corresponds to a prescribed amount, said positional relation amount representing positional relation between a reference position for measuring, for each of said plurality of partial areas, a position of the partial area in said reference image and a position of maximum matching score corresponding to the partial area searched by said position searching unit, and for outputting the calculated score as an image similarity score; and
a determining unit for determining whether said input image and said reference image match with each other, based on an applied said image similarity score.

10. The information processing apparatus according to claim 9, wherein
said similarity score calculating unit calculates, among said plurality of partial areas, the number of said partial areas of which direction and distance from said reference position of corresponding said maximum matching score position searched by said position searching unit correspond to said prescribed amount, and outputs the result of calculation as said image similarity score.

11. The information processing apparatus according to claim 9, wherein
said positional relation amount indicates direction and distance of said maximum matching score position to said reference position.

12. The information processing apparatus according to claim 1, further comprising
an image input unit for inputting an image; wherein
said image input unit has a reading surface on which a finger is placed, for reading a fingerprint image of said finger placed thereon.

13. A method of information processing, for performing a process based on a result of comparison of an image for identifying an individual, using a computer, comprising the steps of:
detecting, in correspondence with each of partial images of said image as an input, a feature value in accordance with a pattern represented by said partial image;
detecting a partial image to be excluded from an object of a comparing process in said input image, based on the feature value output in said feature value detecting step;
performing said comparing process using said input image with said partial image detected in said non-eligibility detecting step excluded; and
calculating ratio of said partial image detected in said step of detecting a partial image, relative to said input image as a whole; wherein
permission or inhibition of a designated application process is controlled by a result of said comparing process by said step of performing the comparing process and by said ratio calculated by said ratio calculating step.

14. An information processing program for causing a computer to execute the information processing method according to claim 13.

15. A computer readable recording medium recording an information processing program for causing a computer to execute the information processing method according to claim 13.
